(19) United States
(12) Patent Application Publication
(10) Pub. No.: US 2008/0118078 A1
(43) Pub. Date: May 22, 2008

(54) Acoustic system, acoustic apparatus, and optimum sound field generation method

(75) Inventors: Kohei Asada, Kanagawa (JP); Makoto Yamagishi, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/977,245

(22) Filed: Oct. 24, 2007

(30) Foreign Application Priority Data
Nov. 16, 2006 (JP) JP2006-310421

(51) Int. Cl. H04R 1/10

(52) U.S. Cl. 381/74

(57) ABSTRACT

The first signal not higher than a predetermined frequency is output to a subwoofer out of the multichannel reproduction signals supplied from a sound source and, at the same time, the second signal higher than the predetermined frequency is output to a plurality of non-closed type headphones and the signals are processed for each of the channels corresponding to a plurality of headphones, considering links of the low tones to be output from the subwoofer according to the first signal and medium to high tones to be output from the plurality of non-closed type headphones according to the second signal.

### CROSS REFERENCES TO RELATED APPLICATIONS

The present invention contains subject matter related to Japanese Patent Application JP 2006-310421 filed in the Japanese Patent Office on Nov. 16, 2006, the entire contents of which being incorporated herein by reference.

### BACKGROUND OF THE INVENTION

1. Field of the Invention

This invention relates to an acoustic system, an acoustic apparatus and an optimum sound filed generation method that can suitably be used for multichannel reproduction systems.

2. Description of the Related Art

Multichannel reproduction systems for reproducing multichannel audio contents by way of a plurality of speakers have rapidly become popular. With such a system, however, if a plurality of listeners is in front of the plurality of speakers, it is only the listener staying at the optimum listening position who can sense the sound image that the contents producer intended to produce because the plurality of listeners are at respective listening positions that are different from each other. In other words, it is difficult for all the plurality of listeners to accurately sense the sound image at the same time.

This is obvious when the wavelength range of audible sounds and the size of a human head are considered. For example, it is only a single spot that is of equidistance from a plurality of speakers on the same horizontal plane when the number of channels, or hence, that of speakers is five.

This fact is based on geometrical elements and it is fundamentally impossible for all of a plurality of listeners to accurately sense the sound image at the same time by using any of the electronic sound field creation means that many audio equipment manufacturing companies start marketing.

Meanwhile, for reference, some multichannel reproduction systems that are being marketed are designed to have a plurality of listeners individually listen to the sound being reproduced by means of headphones and, at the same time, all the listeners simultaneously listen to low tones by means of a subwoofer in a state where the low tone components of audio signals are mixed (see, for example, Pat. Appln. Laid-Open Publication No. 2005-252597).

### SUMMARY OF THE INVENTION

With multichannel reproduction systems having such a configuration, as pointed out above, it is physically inevitable that a plurality of listeners who are in front of a plurality of speakers take respective listening positions that are different from each other and it is only the listener staying at the optimum listening position who can sense the sound image that the contents producer intended to produce, while fundamentally correcting the sound images of the plurality of listeners so that all the plurality of listeners may sense an accurate sound image at the same time. Therefore, if there is a scene of an object that appears to be turning around the listeners in the contents of a DVD (digital versatile disc), for instance, it is only the single listener staying at the center of the group of speakers who can enjoy the proper linkage of sound images that is produced as the object turns around. In other words, there is a problem that all the other listeners staying around that single listener are not able to enjoy the proper linkage of sound images in the same way.

There is another problem of multichannel reproduction systems that reproduced sounds at sound levels of strong appeal to listeners are not able to be output when the influence of sound leaks is considered because reproduced sounds are output by way of a plurality of speakers.

In view of the above-identified problems, it is therefore desirable to provide an acoustic system, an acoustic apparatus and an optimum sound field generation method that are free from sound leaks to the surroundings and can provide a sense of an optimum sound image to all the listeners regardless of listening position.

There is provided an acoustic system according to an aspect of the present invention including a plurality of non-closed type headphones; a subwoofer; a dividing means for outputting the first signal not higher than a predetermined frequency to the subwoofer out of the multichannel reproduction signals supplied from a sound source and, at the same time, outputting the second signal higher than the predetermined frequency to the plurality of non-closed type headphones; and a signal processing means for processing the signals for each of the channels corresponding to the plurality of non-closed type headphones, considering links of the low tones to be output from the subwoofer according to the first signal and medium to high tones to be output from the plurality of non-closed type headphones according to the second signal.

With this arrangement, the plurality of listeners are made to listen to medium to high tones by way of respective non-closed type headphones, while they can listen to low tones by way of a subwoofer and through the gaps between their ears and the headphones that are non-closed type and feel the vibrations of low tones by their entire bodies. Thus, it is possible to provide the reproduced sounds to all of the plurality of listeners at a satisfactory volume level, while remarkably reducing sound leaks to the surroundings. Additionally, signals are processed so as to link low tones and medium to high tones without any strange feeling by considering the difference of distance between the subwoofer that is common to all the listeners and the plurality of listeners so that it is possible to provide a feeling of optimum sound image to all the listeners regardless of their listening positions.

Thus, according to the present invention, it is possible to realize an acoustic system, an acoustic apparatus and an optimum sound field generation method that make the listeners listen to medium to high tones by way of a non-closed type headphone, while they can listen to low tones by way of a subwoofer and through the gaps between their ears and the headphones that are non-closed type and feel the vibrations of low tones by their entire bodies. Thus, it is possible to provide the reproduced sounds to all of the plurality of listeners at a satisfactory volume level, while remarkably reducing sound leaks to the surroundings. Additionally, according to the present invention, signals are processed so as to link low tones and medium to high tones without any strange feeling by considering the difference of distance between the subwoofer that is common to all the listeners and the plurality of listeners so that it is possible to provide a feeling of an optimum sound image to all the listeners regardless of their listening positions.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic illustration of the overall configuration according to a first embodiment of the present invention, which is a multichannel reproduction system;

FIGS. 2A and 2B are schematic block diagrams of the basic circuit of the multichannel reproduction system of the first embodiment;

FIG. 3 is a schematic illustration of the headphone configuration (1) of the first embodiment;

FIGS. 4A and 4B are schematic illustrations of the headphone configuration (2) of the first embodiment;

FIG. 5 is a schematic illustration of the sound image localization technique according to the first embodiment of the present invention when a headphone having a plurality of speaker units is used;

FIG. 6 is a schematic illustration of the sound image localization technique according to the first embodiment of the present invention when a headphone having a left speaker unit and a right speaker unit is used;

FIG. 7 is a schematic illustration of the principle of the sound image localization process according to the first embodiment of the present invention;

FIG. 8 is a schematic block diagram, illustrating the specific circuit configuration (1) of the multichannel reproduction system of the first embodiment;

FIG. 9 is a schematic block diagram, illustrating the specific circuit configuration (2) of the multichannel reproduction system of the first embodiment;

FIG. 10 is a schematic block diagram, illustrating the specific circuit configuration (3) of the multichannel reproduction system of the first embodiment;

FIG. 11 is a schematic block diagram, illustrating the specific circuit configuration (4) of the multichannel reproduction system of the first embodiment;

FIG. 12 is a schematic illustration of the overall configuration according to a second embodiment of the present invention, which is a multichannel reproduction system;

FIG. 13 is a schematic perspective view of an ear speaker type headphone, showing the overall configuration (1) thereof;

FIG. 14 is a schematic perspective view of an ear speaker type headphone, showing the overall configuration (2) thereof;

FIG. 15 is a schematic perspective view of an ear speaker type headphone, showing the overall configuration (3) thereof;

FIG. 16 is a schematic lateral view of the head of a listener, illustrating mode (1) of wearing an ear speaker type headphone;

FIG. 17 is a schematic lateral view of the head of a listener, illustrating mode (2) of wearing an ear speaker type headphone;

FIG. 18 is a schematic cross sectional view of a bass reflex ear speaker type headphone;

FIG. 19 is a graph illustrating the curves of the frequency characteristics of a known bass reflex speaker;

FIG. 20 is a graph illustrating the curves of the frequency characteristics of the ear speaker type headphone employed in the second embodiment of the present invention;

FIG. 21 is a graph illustrating the curves of theoretical frequency characteristics;

FIG. 22 is a graph illustrating the curves of the actually observed frequency characteristics;

FIG. 23 is a schematic cross-sectional view of the head of a listener, illustrating a feedback type noise-canceling technique.

FIG. 24 is a schematic block diagram of a noise-canceling system, illustrating the configuration thereof;

FIG. 25 is a graph illustrating characteristic curves illustrating the phase margin and the gain margin for offsetting the noise;

FIG. 26 is a schematic block diagram of a multichannel reproduction system having a noise-canceling feature, illustrating the configuration thereof;

FIG. 27 is a schematic lateral view illustrating the configuration of the ear speaker type headphone of another embodiment; and

FIG. 28 is a schematic illustration of the sound image localization technique of another embodiment of the present invention when a headphone having a plurality of speaker units is used.

### DETAILED DESCRIPTION OF THE PREFERRED EMBODIMENTS

Now, the present invention will be described by referring to the accompanying drawings that illustrate preferred embodiments of the invention.

### (1) First Embodiment

Firstly, the first embodiment of the present invention, which has the most basic configuration, will be described.

### (1-1) Overall Configuration of Multichannel Reproduction System of the First Embodiment

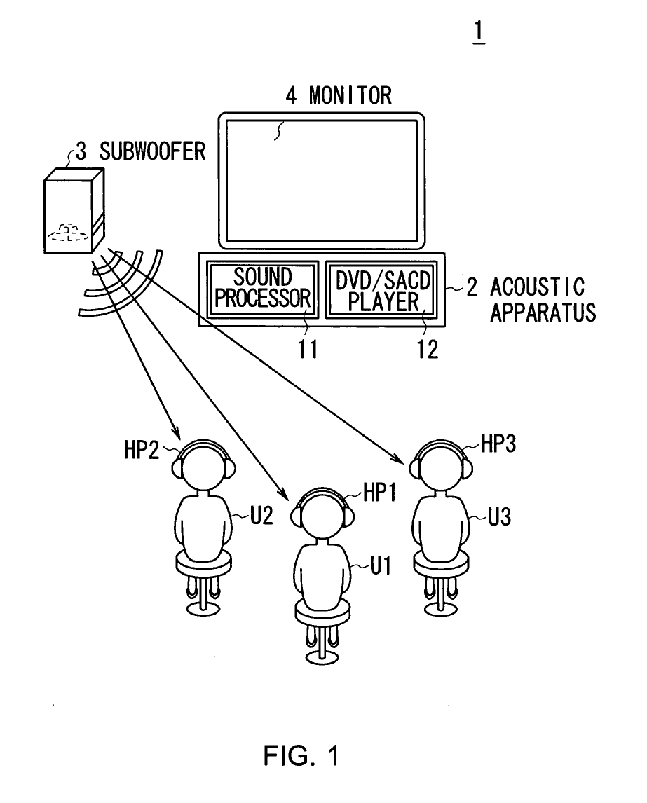

Referring to FIG. 1, 1 generally denotes the multichannel reproduction system of the first embodiment which is designed to provide multichannel audio contents to one or more listeners U1 through U3 in a living room or in some other home environment from a Digital Versatile Disc (DVD), a Super Audio Compact Disc (SACD) or the like with concert hall presence. The multichannel reproduction system 1 includes an acoustic apparatus 2, a subwoofer 3 that operates commonly for the plurality of listeners U1 through U3 staying at arbitrarily selected respective listening positions and headphones HP1 through HP3 that the plurality of listeners U1 through U3 respectively use.

### (1-2) Basic Circuit Configuration of Multichannel

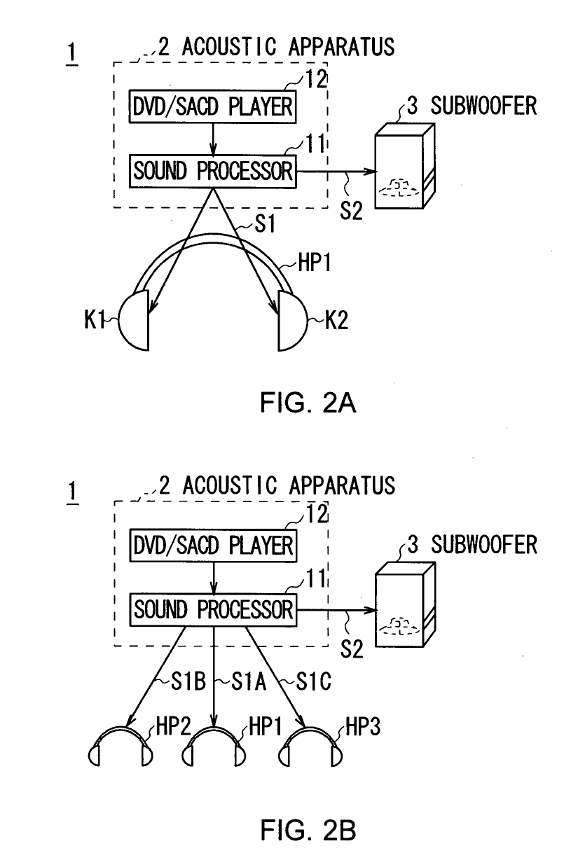

Reproduction System of the First Embodiment Referring now to FIG. 2A, when the multichannel reproduction system 1 is operated for a single listener U1, the reproduced signals for a plurality of channels that are reproduced from the DVD/SACD player 12 of the acoustic apparatus 2 are subjected to a predetermined signal process by way of a sound processor 11 and subsequently divided into medium to high band component signal S1 that is transmitted to the headphone HP1 of the listener U1 by wired or wireless transmission and low band component signal S2 that is output to the subwoofer 3.

The headphone HP1 outputs the medium to high tones of the reproduced sounds from the speaker units (not shown) arranged in the insides of cabinet sections K1 and K2 according to the medium to high band component signal S1 supplied from the sound processor 11.

On the other hand, the subwoofer 3 outputs the low tones of the reproduced sounds that correspond to the low band component signal S2 supplied from the sound processor 11. Thus, as a result, the multichannel reproduction system 1 outputs the medium to high tones and the low tones of the reproduced sounds respectively from the headphone HP1 and the subwoofer 3. Then, those tones are combined to produce the synthetic sound that the listener U1 listens to.

The headphone HP1 is not of the so-called closed type but of the open type. In other words, it is assumed that there is a slight gap between the year pad of each of the cabinet sections K1 and K2 and the corresponding ear of the listener U1.

An open type headphone HP1 does not give a sense of pressure to the user, who is a listener, at and near his or her ears, and the user can wear it comfortably and so on. On the other hand, it has a drawback that the front surface and the rear surface of the diaphragm of each of its speaker units are linked to each other by air and hence it gives rise to a canceling effect for low tones having a long wavelength so that it is not able to satisfactorily reproduce the low tones.

However, with the multichannel reproduction system 1, the listener can listen to all the frequency band of the reproduced sounds as the low tones of the reproduced sounds are covered by the subwoofer 3 connected to the sound processor 11 in addition to the open type headphone HP1 that covers the medium to high tones of the reproduced sounds.

More specifically, the ear pad part of each of the cabinet sections K1 and K2 of the open type headphone HP1 and the corresponding ear of the listener U1 are separated from each other by a gap and hence the listener U1 can listen to the low tones output from the subwoofer 3 by way of the gap.

The subwoofer 3 that reproduces low tones provides the following advantages. In the contents of many movies and so on that are mainly provided by DVDs, the role of low tone reproduction is mainly that of reproducing sound effects such as sounds of explosions and those of closed environments.

It is clear from experiences that not only low tones coming through the ears but also the vibrations that the listener feels from such low tones by his or her entire body are important to the appeal of such sounds. From this point of view, it may be safe to say that the contents of a movie or some other work of art becomes more appealing to the listener U1 and faithfully reflects the contents producer's intention when low tones are reproduced not only from a headphone HP1 but also from a subwoofer 3, which transmits vibrations through the air.

Thus, the multichannel reproduction system 1 is designed to make the listener U1 feel the low tones from the subwoofer 3 by his or her entire body as vibrations in addition to have the listener U1 listen to the low tones from the subwoofer 3 through the gaps between the ear pads of the open type headphone HP1 and the listener's ears.

Similarly, when the multichannel reproduction system 1 is operated for a plurality of listeners U1 through U3 as shown in FIG. 2B, the reproduced signals for a plurality of channels that are reproduced from the DVD/SACD player 12 of the acoustic apparatus 2 are subjected to a predetermined signal process by way of a sound processor 11 and subsequently divided into medium to high band component signal S1 that is transmitted to the headphones HP1 through HP3 of the listeners U1 through U3 by wired or wireless transmission and low band component signal S2 that is output to the subwoofer 3.

In this case, since the distances from the subwoofer 3 to the listeners U1 through U3 are different from each other because the listeners' listening positions are different from each other and the frequency characteristics of the reproduced sounds that get to the listeners U1 through U3 differ from user to user, the sound processor 11 outputs the medium to high band component signals S1A through S1C that are obtained by correcting the time alignment and the frequency characteristics for the listeners U1 through U3, taking those differences into consideration, respectively to the headphones HP1 through HP3 of the listeners U1 through U3.

Then, the headphones HP1 through HP3 output the medium to high tones of the reproduced sounds from the speaker units (not shown) of the headphones HP1 through HP3 according to the medium to high band component signals S1A through S1C supplied to the respective headphones HP1 through HP3 from the sound processor 11.

On the other hand, the subwoofer 3 outputs the low tones of the reproduced sounds that correspond to the low band component signal S2 supplied from the sound processor 11. Thus, as a result, the multichannel reproduction system 1 outputs the medium to high tones and the low tones of the reproduced sounds respectively from the headphones HP1 through HP3 and the subwoofer 3. Then, those tones are combined to produce the sounds that the listeners U1 through U3 listen to.

The headphone HP1 is not of the so-called closed type but of the open type. While an open type headphone HP1 has a drawback that the front surface and the rear surface of the diaphragm of each of its speaker units are linked to each other by air and hence it gives rise to a canceling effect for low tones having a long wavelength so that it is not able to satisfactorily reproduce the low tones, the listeners U1 through U3 can listen to all the frequency band of the reproduced sounds as the low tones of the reproduced sounds are covered by the subwoofer 3 connected to the sound processor 11 in addition to the open type headphones HP1 through HP3 that cover the medium to high tones of the reproduced sounds.

Thus, the multichannel reproduction system 1 is designed to make the listeners U1 through U3 feel the low tones from the subwoofer 3 by their entire bodies as vibrations in addition to have the listeners U1 through U3 listen to the low tones from the subwoofer 3 through the gaps between the ear pads of the open type headphones HP1 through HP3 and the listeners' ears.

### (1-3) Configuration of Headphone of the First Embodiment

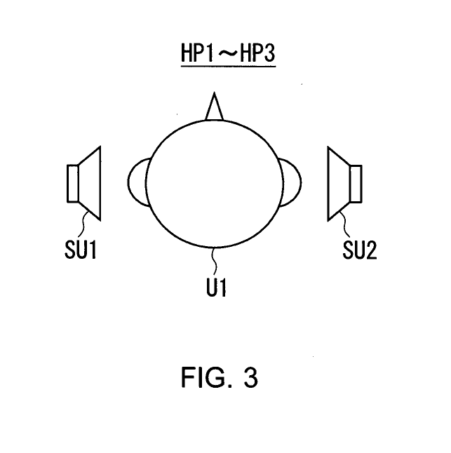

Each of the headphones HP1 through HP3 may have two speaker units SU1 and SU2 arranged therein, one for the left ear and the other for the right ear of the corresponding listener, or listener U1 for example as shown in FIG. 3.

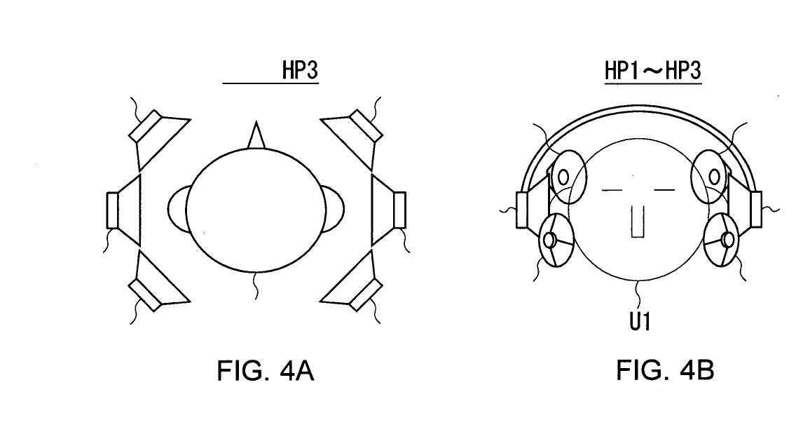

Each of the headphones HP1 through HP3 may still have speaker units SU3 and SU4 arranged respectively in front of the speaker units SU1 and SU2, which are arranged at the outer lateral sides of the ears of the head of the listener U1 for example, and speaker units SU5 and SU6 arranged respectively at the back of the speaker units SU2 as shown in FIGS. 4A and 4B. In FIGS. 4A and 4B, the components that corresponds those of FIG. 3 are denoted respectively by the same reference symbols.

Then, the speaker units SU1 through SU6 are arranged to surround the listener U1 from the front side, from the lateral sides and from the rear side.

### (1-4) Sound Image Localization Technique of the First Embodiment

The sound image localization technique of this embodiment when headphones HP1 through HP3 are used and each of them has speaker units SU1, SU3 and SU5 arranged at the outer lateral side of the left ear and speaker units SU2, SU4 and SU6 arranged at the outer lateral side of the right ear (FIGS. 4A and 4B) and the sound image localization technique of this embodiment when headphones HP1 through HP3 are used and each of them has speaker units SU1 and SU2 arranged therein, one for the left ear and the other for the right ear of the corresponding listener, (FIG. 3) will be described below. Only the headphone HP1, out of the headphones HP1 through HP3, will be described as a matter of convenience.

### (1-4-1) Sound Image Localization Technique for Headphone Having a Plurality of Speaker Units Arranged at Each of Opposite Lateral Sides

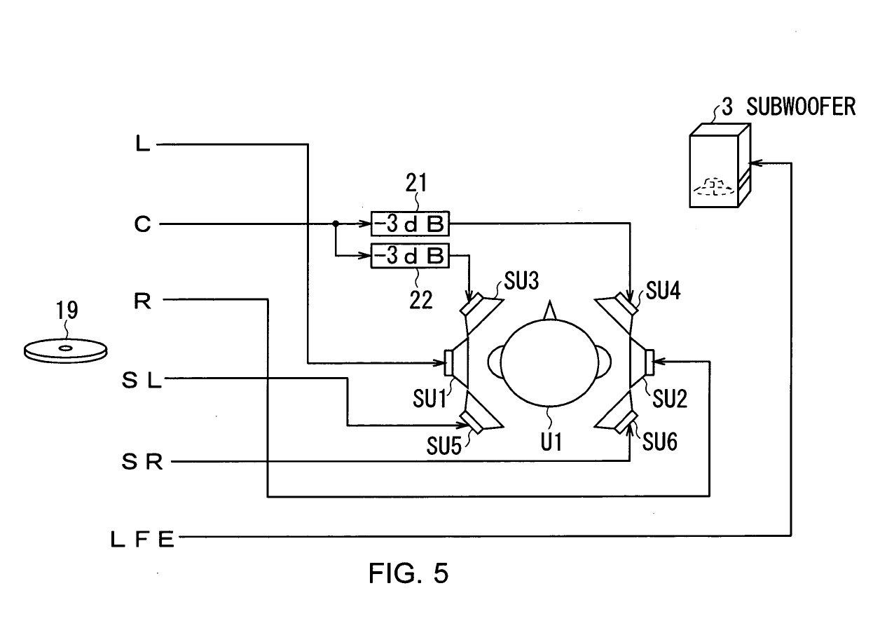

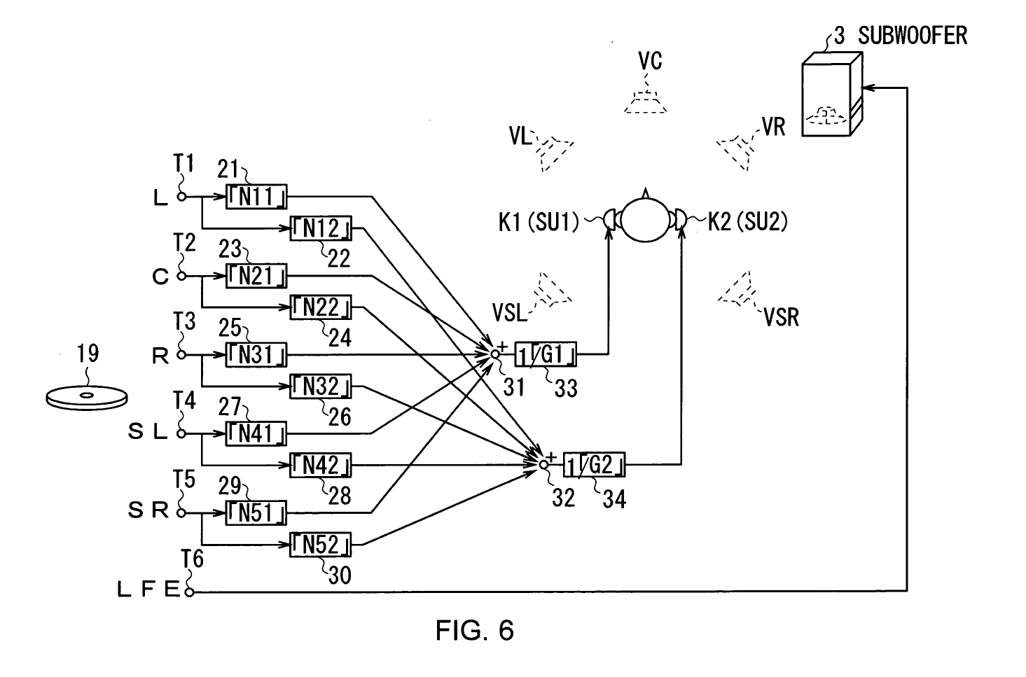

In the case of headphone HP1 having a plurality of speaker units SU1 through SU6 as shown in FIGS. 4A and 4B, the listener can feel the direction of any sound image and hence make sound image localization according to the contents producer's intention as the audio signals of multichannel audio contents for 5.1ch reproduced from DVD 19 that is a 5.1ch sound source are output by way of the individual speaker units SU1 through SU6 for the L-channel for the left front speaker, the R-channel for the right front speaker, the C-channel for the center speaker, the SL-channel for the left surround speaker and the SR-channel for the right surround speaker as shown in FIG. 5.

As for the audio signal output from the C-channel for the center speaker, when the audio signal of the C-channel is output to the speaker units SU3 and SU4, the volume level of the C-channel for the center speaker rises relative to that of any of the other channels (L-channel, R-channel, SL-channel and SR-channel) to put it out of balance. Therefore, to avoid this problem, the gain of the audio signal is reduced by −3 dB by means of level reduction circuits 21 and 22 before it is supplied to the speaker units SU3 and SU4.

Since the low band component signal supplied to the Low Frequency Effect (LFE) channel corresponds to the frequency band that intrinsically does not give any sense of direction of sound image so that it is output to the subwoofer 3 in the ordinary way.

Thus, with the multichannel reproduction system 1, when an object is turning around a plurality of listeners staying in front of the system in a scene, anyone of the listeners can feel the direction of the sound image of the object that exactly matches the current position of the turning object regardless of the listening position of the listener because the medium to high tones of the audio signals of the reproduced sounds giving a feeling of direction of sound image and corresponding to the multichannel audio contents that are being reproduced by the system are output by the headphone HP1 having a plurality of speaker units SU1 through SU6.

### (1-4-2) Sound Image Localization Technique for Headphone Having a Left Speaker Unit and a Right Speaker Unit

In the case of headphone HP1 having speaker units SU1 and SU2 arranged respectively at the outer lateral side of the left ear and at the outer lateral side of the right ear as shown in FIG. 3, it is necessary to make the listener feel that the sound image of the reproduced sounds output from the speaker units SU1 and SU2 arranged in the left and right cabinet sections K1 and K2 of the headphone HP1 of the multichannel reproduction system 1 is localized in such a way that he or she feels as if sounds were output from a virtual left channel VL, a virtual right channel VR, a virtual center channel VC, a virtual surround left channel VSL and a virtual surround right channel VSR.

Then, the multichannel reproduction system 1 can make the listener feel the reproduced sounds output from the left and right speaker units SU1 and SU2 as if they were output from the virtual left channel VL, the virtual right channel VR, the virtual center channel VC, the virtual surround left channel VSL and the virtual surround right channel VSR so that it can provide stereophonic reproduced sounds of concert hall presence to the listener who is listening to the multichannel audio contents of the DVD or the like by way of a monitor 4 (FIG. 4).

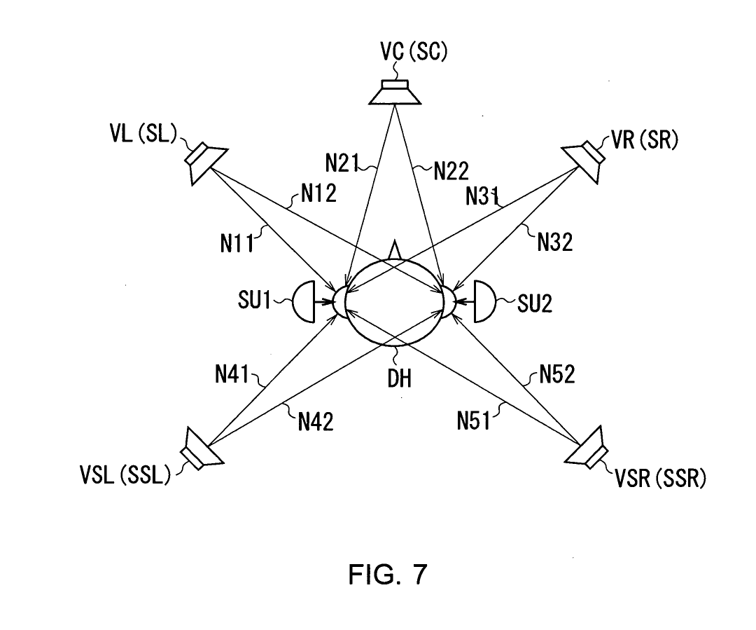

Now, the principle of a sound image localization process for moving a sound image will be described below. Referring to FIG. 7, a left speaker SL, a right speaker SR, a center speaker SC, a left surround speaker SSL and a right surround speaker SSR are arranged for a listener who may be at the position of a dummy head DH in a predetermined reproduced sound field relative to virtual speaker positions of a virtual left channel VL, a virtual right channel VR, a virtual center channel VC, a virtual surround left channel VSL and a virtual surround right channel VSR.

Then, the reproduced sounds emitted from the left speaker SL, the right speaker SR, the center speaker SC, the left surround speaker SSL and the right surround speaker SSR are collected by the ears of the dummy head DH and the head related transfer functions (HRTFs), which indicate how the reproduced sounds emitted from the left speaker SL, the right speaker SR, the center speaker SC, the left surround speaker SSL and the right surround speaker SSR change, are observed in advance.

Note that the head related transfer function of the reproduced sounds from the left speaker SL to the left ear of the dummy head DH is N11 and the head related transfer function of the reproduced sounds from the left speaker SL to the right ear of the dummy head DH is N12.

Similarly, the head related transfer function of the reproduced sounds from the center speaker SC to the left ear of the dummy head DH is N21 and the head related transfer function of the reproduced sounds from the center speaker SC to the right ear of the dummy head DH is N22.

Likewise, the head related transfer function of the reproduced sounds from the right speaker SR to the left ear of the dummy head DH is N31 and the head related transfer function of the reproduced sounds from the right speaker SR to the right ear of the dummy head DH is N32.

Additionally, the head related transfer function of the reproduced sounds from the left surround speaker SSL to the left ear of the dummy head DH is N41 and the head related transfer function of the reproduced sounds from the left surround speaker SSL to the right ear of the dummy head DH is N42, whereas the head related transfer function of the reproduced sounds from the right surround speaker SSR to the left ear of the dummy head DH is N51 and the head related transfer function of the reproduced sounds from the right surround speaker SSR to the right ear of the dummy head DH is N52.

As the signals are subjected to a signal process by means of the head related transfer functions N that are observed in advance and the reproduced sounds that correspond to the audio signals subjected to the signal process are emitted accordingly, it is possible to localize the sound images of the signals in such a way that the listener feels as if the reproduced sounds that are actually emitted from the speaker units SU1 and the SU2 of the headphone HP1 were emitted from the virtual left channel VL, the virtual right channel VR, the virtual center channel VC, the virtual surround left channel VSL and the virtual surround right channel VSR.

While a dummy head DH is used when observing the head related transfer functions N in the above description, the present invention is by no means limited thereto and the head related transfer functions N may alternatively be determined by having a person actually sit at the position of the dummy head DH, placing microphones at positions close to the ears of the person and observing the head related transfer functions N or by way of simulation.

More specifically, the audio signals reproduced from the DVD 19 that is a 5.1ch sound source are supplied for each of the channels by way of left channel terminal T1, center channel terminal T2, right channel terminal T3, surround left channel terminal T4, surround right channel terminal T5 and LFE channel terminal T6.

The L-channel audio signal input by way of the left channel terminal T1 is output to sound image localization process filters 21 and 22 and the C-channel audio signal input by way of the center channel terminal T2 is output to sound image localization process filters 23 and 24, while the R-channel audio signal input by way of the right channel terminal T3 is output to sound image localization process filters 25 and 26 and the SL-channel audio signal and the SR-channel audio signal respectively input by way of the surround left channel terminal T4 and the surround right channel terminal T5 are output to sound image localization process filters 27 and 28 and sound image localization process filters 29 and 30.

The sound image localization process filter 21 executes a signal process on the L-channel audio signal supplied by way of the left channel terminal T1 by means of the head related transfer function “N11” and subsequently transmits it to an adder 31. The sound image localization process filter 22 also executes a signal process on the L-channel audio signal supplied by way of the left channel terminal T1 by means of the head related transfer function “N12” and subsequently transmits it to an adder 32.

The sound image localization process filter 23 executes a signal process on the C-channel audio signal supplied by way of the center channel terminal T2 by means of the head related transfer function “N21” and subsequently transmits it to the adder 31. The sound image localization process filter 24 also executes a signal process on the C-channel audio signal supplied by way of the center channel terminal T2 by means of the head related transfer function “N22” and subsequently transmits it to the adder 32.

The sound image localization process filter 25 executes a signal process on the R-channel audio signal supplied by way of the right channel terminal T3 by means of the head related transfer function “N31” and subsequently transmits it to the adder 31. The sound image localization process filter 26 also executes a signal process on the R-channel audio signal supplied by way of the right channel terminal T3 by means of the head related transfer function “N32” and subsequently transmits it to the adder 32.

The sound image localization process filter 27 executes a signal process on the SL-channel audio signal supplied by way of the surround left channel terminal T4 by means of the head related transfer function “N41” and subsequently transmits it to the adder 31. The sound image localization process filter 28 also executes a signal process on the SL-channel audio signal supplied by way of the surround left channel terminal T4 by means of the head related transfer function “N42” and subsequently transmits it to the adder 32.

The sound image localization process filter 29 executes a signal process on the SR-channel audio signal supplied by way of the surround right channel terminal T5 by means of the head related transfer function “N51” and subsequently transmits it to the adder 31. The sound image localization process filter 30 also executes a signal process on the SR-channel audio signal supplied by way of the surround right channel terminal T5 by means of the head related transfer function “N52” and subsequently transmits it to the adder 32.

The adder 31 adds the audio signals of these channels supplied from the sound image localization process filter 21, the sound image localization process filter 23, the sound image localization process filter 25, the sound image localization process filter 27 and the sound image localization process filter 29 and transmits the synthetic signal obtained as a result of the addition to a trans-aural filter 33.

The adder 32 similarly adds the audio signals of these channels supplied from the sound image localization process filter 22, the sound image localization process filter 24, the sound image localization process filter 26, the sound image localization process filter 28 and the sound image localization process filter 30 and transmits the synthetic signal obtained as a result of the addition to a trans-aural filter 34.

The trans-aural filters 33 and 34 are used because if the reproduced sounds emitted from the speaker units SU1 and SU2 of the headphone HP1 are subjected to a sound image localization process by the sound image localization process filters 21 through 30, they are influenced by the head related transfer functions “G1” and “G2” from the speaker units SU1 and SU2 to the ears so that the sound image of the reproduced sounds may be able to be localized to the positions of the virtual speakers.

Thus, the synthetic signals output respectively from the adders 31 and 32 are multiplied by 1/“G1” and 1/“G2” by means of the trans-aural filters 33 and 34 to eliminate the influences of the transfer functions “G1” and “G2” and the corrected synthetic signals obtained as a result are output to the speaker units SU1 and SU2 of the headphone HP1 so that the reproduced sounds emitted from the speaker units SU1 and SU2 of the headphone HP1 are accurately localized and the listener feels as if the reproduced sounds are emitted from the left speaker SL, the right speaker SR, the center speaker SC, the left surround speaker SSL and the right surround speaker SSR arranged at the respective virtual speaker positions.

Therefore, in this case again, it is possible to make the listener U1 using the headphone HP1 can feel that the reproduced sounds emitted from the speaker units SU1 and SU2 are coming from the virtual speaker positions and hence anyone of the listeners can feel the direction of the sound image of the object that exactly matches the current position of the object turning around the listener regardless of the listening position of the listener

Note that, the low band component signal that is not related to sound image localization is supplied to the subwoofer 3 by way of the LFE channel terminal 6 and the low tones of the reproduced sounds are emitted from the subwoofer 3.

Thus, with either the sound image localization technique for the headphones HP1 through HP3, each having speaker units SU1, SU3 and SU5 arranged at the outer lateral side of the left ear and speaker units SU2, SU4 and SU6 arranged at the outer lateral side of the right ear or the sound image localization technique for the headphones HP1 through HP3, each having speaker units SU1 and SU2 arranged respectively at the outer lateral side of the left ear and at the outer lateral side of the right ear, it is possible to give a feeling of direction of sound image to the listeners according to the intention of the contents producer.

### (1-5) Specific Circuit Configuration of Multichannel Reproduction System of the First Embodiment

The basic configuration of the multichannel reproduction system according to the first embodiment of the present invention is described above. Now, a by far realistic application of the present invention will be described below.

Any of the listeners using the headphones HP1 through HP3 of the above-described multichannel reproduction system 1 listens to the synthetic sounds of the reproduced sound output from the corresponding one of the headphones HP1 through HP3 and the reproduced sound output from the subwoofer 3. However, if the gains (volumes), the delays and the cross curves (the characteristics and the behaviors of the two reproduced sounds at and near the reproduction limit frequency) of the two reproduced sounds differ from each other to a large extent at the positions of the ears of the listener, the two sounds show a poor link.

Then, as a result, there may arise a phenomenon where the listener can hear only either of the two reproduced sounds, a phenomenon where the listener hears the two reproduced sounds as two isolated sounds, a (dip) phenomenon where the sound component of a specific frequency band of the reproduction band dips and becomes inaudible and/or a (peak) phenomenon where the sound level of a specific frequency band rises abruptly to give a strange feeling to the listener.

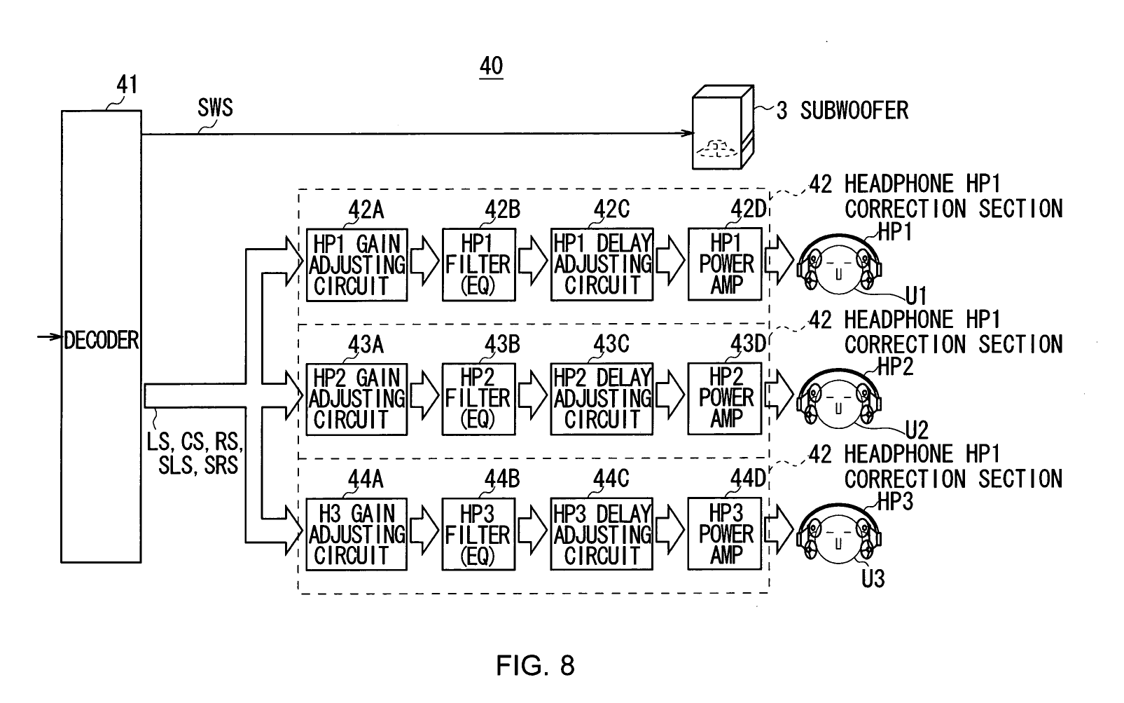

Additionally, when a plurality of listeners U1 through U3 listen to the reproduced sounds as shown in FIG. 1, the positional relationship between the subwoofer 3 and the headphones HP1 through HP3 differs among the listeners U1 through U3 so that the characteristics of the reproduced sounds vary due to spatial factors (including distance, reflection of wall, standing wave, type of headphone, etc.) to make the problem more serious. Thus, according to the embodiment of the present invention, the above problem is dissolved by configuring systems as shown in FIGS. 8 through 11.

### (1-5-1) Multichannel Reproduction System Using Headphones, Each Having a Plurality of Speaker Units

In a multichannel reproduction system 40 including headphones HP1 through HP3 (FIG. 4), each having a plurality of speaker units SU1 through SU6, as shown in FIG. 8, the low band component signal SWS of the LFE channel of the multichannel audio contents of 5.1ch supplied from a decoder 41 is output to the subwoofer 3, while the left speaker audio signal LS of the L-channel, the right speaker audio signal RS of the R-channel, the center speaker audio signal CS of the C-channel, the left surround audio signal SLS of the SL-channel and the right surround audio signal SRS of the SR-channel are sent out to a headphone HP1 correction section 42, a headphone HP2 correction section 43 and a headphone HP3 correction section 44.

The headphone HP1 correction section 42 adjusts the audio signals of those channels (LS, RS, CS, SLS, SRS) so as to make each of them show gains and filter characteristics (of the equalizer, the low pass filter and so on) and a delay that suitably correspond to the distance from the subwoofer 3 to the listener U1 using the headphone HP1 by way of a HP1 gain adjusting circuit 42A, HP1 filter 42B and HP1 delay adjusting circuit 42C and also adjusts the sound pressure level by way of the HP1 power amplifier 42D. Then, it outputs the medium to high tones of the multichannel audio contents by way of the headphone HP1 of the listener U1.

Similarly, the headphone HP2 correction section 43 adjusts the audio signals of those channels (LS, RS, CS, SLS, SRS) so as to make each of them show gains and filter characteristics (of the equalizer, the low pass filter and so on) and a delay that suitably correspond to the distance from the subwoofer 3 to the listener U2 using the headphone HP2 by way of an HP2 gain adjusting circuit 43A, an HP2 filter 43B and an HP2 delay adjusting circuit 43C and also adjusts the sound pressure level by way of an HP2 power amplifier 43D. Then, it outputs the medium to high tones of the multichannel audio contents by way of the headphone HP2 of the listener U2.

Likewise, the headphone HP3 correction section 44 adjusts the audio signals of those channels (LS, RS, CS, SLS, SRS) so as to make each of them show gains and filter characteristics (of the equalizer, the low pass filter and so on) and a delay that suitably correspond to the distance from the subwoofer 3 to the listener U3 using the headphone HP3 by way of an HP3 gain adjusting circuit 44A, an HP3 filter 44B and an HP3 delay adjusting circuit 44C and also adjusts the sound pressure level by way of the HP3 power amplifier 44D. Then, it outputs the medium to high tones of the multichannel audio contents by way of the headphone HP3 of the listener U3.

Thus, the multichannel reproduction system 40 adjusts the audio signals (LS, RS, CS, SLS, SRS) of the channels to make them show gains and filter characteristics (of the equalizer, the low pass filter and so on) and a delay that suitably correspond to the distances from the subwoofer 3 to the listeners U1 through U3 using the headphones HP1 through HP3 respectively by means of the headphone HP correction sections 42 through 44 and then outputs the medium to high tones of the multichannel audio contents by way of the headphones HP1 through HP3 of the listeners U1 through U3. Thus, it is possible to give a comfortable feeling of direction of sound image to all the listeners U1 through U3.

Meanwhile, the multichannel reproduction system 40 makes all the listeners U1 through U3 listen to low tones that are not related to directionality from the subwoofer 3 so that all the listeners U1 through U3 can satisfactorily listen to low tones not only by way of their ears but also by way of their entire bodies.

### (1-5-2) Bass-Management-Applied Multichannel Reproduction System Using Headphones, Each Having a Plurality of Speaker Units

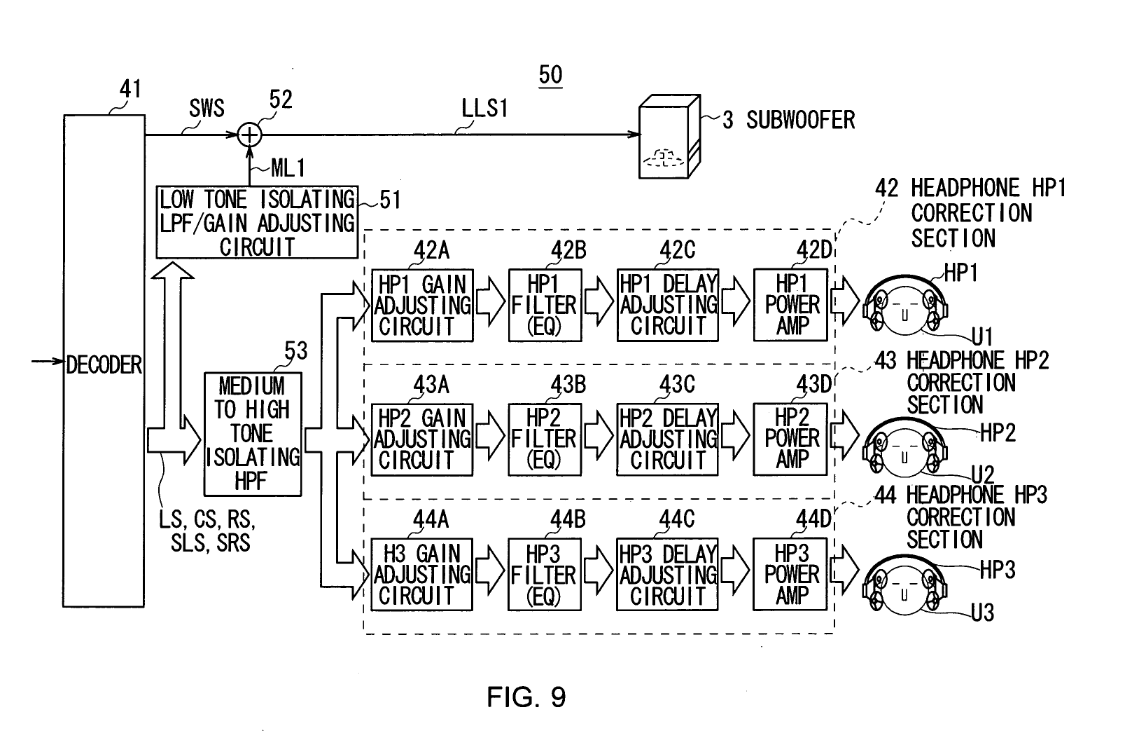

FIG. 9 shows the configuration of a multichannel reproduction system 50 including headphones HP1 through HP3, each having a plurality of speaker units SU1 through SU6, which is realized by applying bass management to the above-described multichannel reproduction system 40 (FIG. 8). In FIG. 9, the components that correspond to those of FIG. 8 are denoted respectively by the same reference symbols.

With a system including a large number of speakers including a left speaker, a center speaker, a right speaker, a left surround speaker and a right surround speaker, when low tones are output from each of the speakers, they can interfere with each other to give a strange feeling to the listeners. Bass management is a technique of outputting low tones only from the subwoofer and allowing all the other speakers to output only medium to high tones but not any low tones in order to prevent interference of low tones from taking place.

When the speakers other than the subwoofer of this bass-management-applied system are small sized speakers, the system can prohibit the small sized speakers from outputting low tones and allow only the subwoofer to output low tones so that it is possible to prevent output distortions and destruction of any of the small sized speakers from taking place.

In actuality, in the bass-management-applied multichannel reproduction system 50, the low band component signal SWS of the LFE channel of the multichannel audio contents of 5.1ch supplied from the decoder 41 is output to an adder circuit 53, while the left speaker audio signal LS of the L-channel, the right speaker audio signal RS of the R-channel, the center speaker audio signal CS of the C-channel, the left surround audio signal SLS of the SL-channel and the right surround audio signal SRS of the SR-channel are sent out to low tone isolating low pass filter/gain adjusting circuit 51 and medium to high tone isolating high pass filter 53.

The low tone isolating low pass filter/gain adjusting circuit 51 isolates only the low band component signals of the audio signals (LS, RS, CS, SLS, SRS) of the channels supplied from the decoder 41 by means of a low pass filter and adjusts the gains thereof. Then, it generates a synthetic low band component signal ML1 by mixing the channels and sends it out to an adder circuit 52.

The adder circuit 52 adds the low band component signal SWS of the LFE channel supplied from the decoder 41 and the synthetic low band component signal ML1 and outputs low band signal LLS1 that is obtained by the addition to the subwoofer 3. In this way, it is possible to output all the low tones of the multichannel audio contents from the subwoofer 3.

On the other hand, the medium to high tone isolating high pass filter 53 isolates only the medium to high band component signals of the audio signals (LS, RS, CS, SLS, SRS) of the channels supplied from the decoder 41 by means of a high pass filter and adjusts the gains thereof. Then, it sends out the medium to high band component signals obtained as a result of the isolation to the headphone HP1 correction section 42, the headphone HP2 correction section 43 and the headphone HP3 correction section 44.

The headphone HP1 correction section 42 adjusts the medium to high band component signals of those channels so as to make each of them show gains and filter characteristics (of the equalizer, the low pass filter and so on) and a delay that suitably correspond to the distance from the subwoofer 3 to the listener U1 using the headphone HP1 by way of the HP1 gain adjusting circuit 42A, HP1 filter 42B and HP1 delay adjusting circuit 42C and also adjusts the sound pressure level by way of the HP1 power amplifier 42D. Then, it outputs the medium to high tones of the multichannel audio contents by way of the plurality of speaker units SU1 through SU6 of the headphone HP1 of the listener U1.

Similarly, the headphone HP2 correction section 43 adjusts the medium to high band component signals of those channels so as to make each of them show gains and filter characteristics (of the equalizer, the low pass filter and so on) and a delay that suitably correspond to the distance from the subwoofer 3 to the listener U2 using the headphone HP2 by way of the HP2 gain adjusting circuit 43A, HP2 filter 43B and HP2 delay adjusting circuit 43C and also adjusts the sound pressure level by way of the HP2 power amplifier 43D. Then, it outputs the medium to high tones of the multichannel audio contents by way of the plurality of speaker units SU1 through SU6 by way of the headphone HP2 of the listener U2.

Likewise, the headphone HP3 correction section 44 adjusts the medium to high band component signals of those channels so as to make each of them show gains and filter characteristics (of the equalizer, the low pass filter and so on) and a delay that suitably correspond to the distance from the subwoofer 3 to the listener U3 using the headphone HP3 by way of the HP3 gain adjusting circuit 44A, HP3 filter 44B and HP3 delay adjusting circuit 44C and also adjusts the sound pressure level by way of the HP3 power amplifier 44D. Then, it outputs the medium to high tones of the multichannel audio contents by way of the plurality of speaker units SU1 through SU6 of the headphone HP3 of the listener U3.

Thus, the bass-management-applied multichannel reproduction system 50 adjusts the medium to high band component signals of the audio signals (LS, RS, CS, SLS, SRS) of the channels to make them show gains and filter characteristics (of the equalizer, the low pass filter and so on) and a delay that suitably correspond to the distances from the subwoofer 3 to the listeners U1 through U3 using the headphones HP1 through HP3 respectively by means of the headphone HP correction sections 42 through 44 and then outputs only the medium to high tones of the multichannel audio contents by way of the headphones HP1 through HP3 of the listeners U1 through U3. Thus, it is possible to give a comfortable feeling of direction of sound image to all the listeners U1 through U3.

Meanwhile, the multichannel reproduction system 50 makes all the listeners U1 through U3 listen to low tones that are not related to directionality from the subwoofer 3 so that all the listeners U1 through U3 can satisfactorily listen to low tones not only by way of their ears but also by way of their entire bodies.

Additionally, the multichannel reproduction system 50 can make only the subwoofer 3 output low tones and the headphones HP1 through HP3 output not any low tones but only medium to high tones so as to prevent any interference that can take place when medium to high tones are output from the speakers from occurring because bass management is applied to it.

While the speaker units SU1 through SU6 of the headphones HP1 through HP3 of this bass-management-applied system 50 are small sized speakers, the system can prohibit the small sized speakers from outputting low tones and allow only the subwoofer 3 to output low tones as a result of applying the idea of bass management so that it is possible to prevent output distortions and destruction of any of the speaker units SU1 through SU6 from taking place.

### (1-5-3) Multichannel Reproduction System Using Headphones, Each Having a Left Speaker Unit and a Right Speaker Unit

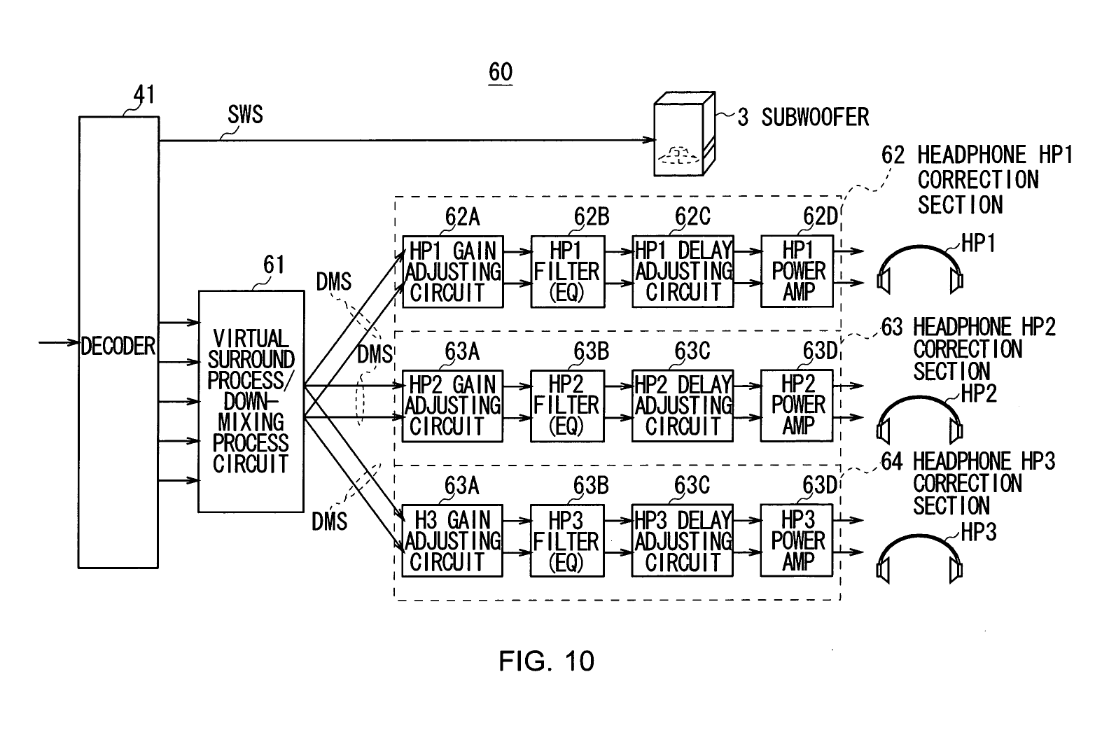

FIG. 10 shows the configuration of a multichannel reproduction system 60 including headphones HP1 through HP3, each having a left speaker unit SU1 and a right speaker unit SU2 (FIG. 3). In FIG. 10, the components that correspond to those of FIG. 8 are denoted respectively by the same reference symbols. In the multichannel reproduction system 60, the low band component signal SWS of the LFE channel of the multichannel audio contents of 5.1ch supplied from the decoder 41 is output to the subwoofer 3, while the left speaker audio signal LS of the L-channel, the right speaker audio signal RS of the R-channel, the center speaker audio signal CS of the C-channel, the left surround audio signal SLS of the SL-channel and the right surround audio signal SRS of the SR-channel are sent out to a virtual surround process/down-mixing process circuit 61.

The virtual surround process/down-mixing process circuit 61 executes a virtual surround signal process on the audio signals of the channels (LS, RS, CS, SLS, SRS) by means of the sound image localization process filter 21, sound image localization process filter 23, sound image localization process filter 25, sound image localization process filter 27 and sound image localization process filter 29 according to the above-described sound image localization technique (FIGS. 7 and 8) and also a down-mixing process on the audio signals in order to make the multichannel audio contents of 5.1ch match the headphone HP1 having 2ch speaker units SU1 and SU2. Then, it sends out the down-mixed signals DMS of 2 channels obtained as a result to a headphone HP1 correction section 62, a headphone HP2 correction section 63 and a headphone HP3 correction section 64, respectively.

The headphone HP1 correction section 62 adjusts the down-mixed signal DMS so as to make it show gains and filter characteristics (of the equalizer, the low pass filter and so on) and a delay that suitably correspond to the distance from the subwoofer 3 to the listener U1 using the headphone HP1 by way of an HP1 gain adjusting circuit 62A, an HP1 filter 62B and an HP1 delay adjusting circuit 62C and also adjusts the sound pressure level by way of an HP1 power amplifier 62D. Then, it outputs the medium to high tones of the multichannel audio contents in two channels from the speaker units SU1 and SU2 by way of the headphone HP1 of the listener U1.

Similarly, the headphone HP2 correction section 63 adjusts the down-mixed signal DMS so as to make it show gains and filter characteristics (of the equalizer, the low pass filter and so on) and a delay that suitably correspond to the distance from the subwoofer 3 to the listener U2 using the headphone HP2 by way of an HP2 gain adjusting circuit 63A, an HP2 filter 63B and an HP2 delay adjusting circuit 63C and also adjusts the sound pressure level by way of an HP2 power amplifier 63D. Then, it outputs the medium to high tones of the multichannel audio contents in two channels from the speaker unit SU1 and SU2 by way of the headphone HP2 of the listener U2.

Likewise, the headphone HP3 correction section 64 adjusts the down-mixed signal DMS so as to make it show gains and filter characteristics (of the equalizer, the low pass filter and so on) and a delay that suitably correspond to the distance from the subwoofer 3 to the listener U3 using the headphone HP3 by way of an HP3 gain adjusting circuit 64A, an HP3 filter 64B and an HP3 delay adjusting circuit 64C and also adjusts the sound pressure level by way of an HP3 power amplifier 64D. Then, it outputs the medium to high tones of the multichannel audio contents in two channels from the speaker units SU1 and SU2 by way of the headphone HP3 of the listener U3.

Thus, the multichannel reproduction system 60 adjusts the down-mixed signal DMS to make it show gains and filter characteristics (of the equalizer, the low pass filter and so on) and a delay that suitably correspond to the distances from the subwoofer 3 to the listeners U1 through U3 using the headphones HP1 through HP3 respectively by means of the headphone HP1 correction section 62 through the headphone HP3 correction section 64 and then outputs the medium to high tones of the multichannel audio contents in two channels by way of the headphones HP1 through HP3 of the listeners U1 through U3. Thus, it is possible to give a comfortable feeling of direction of sound image to all the listeners U1 through U3.

Meanwhile, the multichannel reproduction system 60 makes all the listeners U1 through U3 listen to low tones that are not related to directionality from the subwoofer 3 so that all the listeners U1 through U3 can satisfactorily listen to low tones not only by way of their ears but also by way of their entire bodies.

### (1-5-4) Bass-Management-Applied Multichannel Reproduction System Using Headphones, Each Having a Left Speaker Unit and a Right Speaker Unit

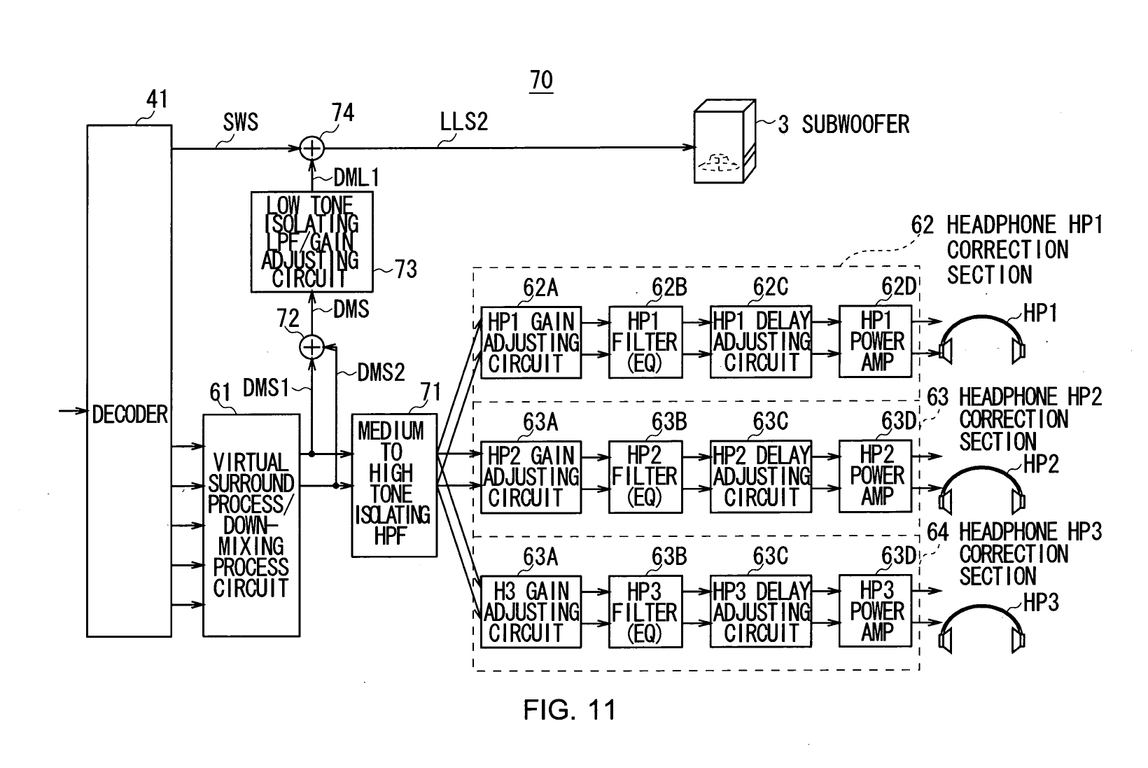

FIG. 11 shows the configuration of a multichannel reproduction system 70 including headphones HP1 through HP3, each having a left speaker unit SU1 and a right speaker unit SU2, which is realized by applying bass management to the above-described multichannel reproduction system 60 (FIG. 3). In FIG. 11, the components that correspond to those of FIG. 10 are denoted respectively by the same reference symbols.

In reality, in the bass-management-applied multichannel reproduction system 70, the low band component signal SWS of the LFE channel of the multichannel audio contents of 5.1ch supplied from the decoder 41 is output to an adder circuit 74, while the left speaker audio signal LS of the L-channel, the right speaker audio signal RS of the R-channel, the center speaker audio signal CS of the C-channel, the left surround audio signal SLS of the SL-channel and the right surround audio signal SRS of the SR-channel are sent out to the virtual surround process/down-mixing process circuit 61.

The virtual surround process/down-mixing process circuit 61 executes a virtual surround signal process on the audio signals of the channels (LS, RS, CS, SLS, SRS) by means of the sound image localization process filter 21, sound image localization process filter 23, sound image localization process filter 25, sound image localization process filter 27 and sound image localization process filter 29 according to the above-described sound image localization technique (FIGS. 7 and 8) and also a down-mixing process on the audio signals in order to make the multichannel audio contents of 5.1ch match the headphone HP1 having 2ch speaker units SU1 and SU2. Then, it sends out the down-mixed signals DMS1 DMS2 obtained as a result (down-mixed signal DMS for two channels) to an adder circuit 72 and medium to high tone isolating high pass filter 71.

The medium to high tone isolating high pass filter 71 isolates only the medium to high band component signal of the down-mixed signal DMS supplied from the virtual surround process/down-mixing process circuit 61 by means of a high pass filter and sends out the medium to high band component signal for two channels obtained as a result to the headphone HP1 correction section 62, the headphone HP2 correction section 63 and the headphone HP3 correction section 64.

The adder circuit 72 adds the down-mixed signals DMS1 and DMS2 and sends out the synthetically combined down-mixed signal DMS obtained as a result to the low tone isolating low pass filter/gain adjusting circuit 73.

The low tone isolating low pass filter/gain adjusting circuit 73 isolates only the low band component signals of the down-mixed signal DMS supplied from the adder circuit 72 by means of a low pass filter and adjusts the gains thereof to generate a down-mixed low band component signal DML1. Then, it sends out the generated down-mixed low band component signal DML1 to the adder circuit 74.

The adder circuit 74 adds the low band component signal SWS of the LFE channel supplied from the decoder 41 and the down-mixed low band component signal DML1 and outputs a low band signal LLS2 that is obtained by the addition to the subwoofer 3. In this way, it is possible to output all the low tones of the multichannel audio contents from the subwoofer 3.

The headphone HP1 correction section 62 adjusts the medium to high band signal of the down-mixed signal DMS for two channels so as to make it show gains and filter characteristics (of the equalizer, the low pass filter and so on) and a delay that suitably correspond to the distance from the subwoofer 3 to the listener U1 using the headphone HP1 by way of the HP1 gain adjusting circuit 62A, HP1 filter 62B and HP1 delay adjusting circuit 62C and also adjusts the sound pressure level by way of the HP1 power amplifier 62D. Then, it outputs the medium to high tones of the multichannel audio contents in two channels from the speaker units SU1 and SU2 by way of the headphone HP1 of the listener U1.

Similarly, the headphone HP1 correction section 63 adjusts the medium to high band signal of the down-mixed signal DMS for two channels so as to make it show gains and filter characteristics (of the equalizer, the low pass filter and so on) and a delay that suitably correspond to the distance from the subwoofer 3 to the listener U2 using the headphone HP2 by way of the HP2 gain adjusting circuit 63A, HP2 filter 63B and HP2 delay adjusting circuit 63C and also adjusts the sound pressure level by way of the HP2 power amplifier 63D. Then, it outputs the medium to high tones of the multichannel audio contents in two channels from the speaker units SU1 and SU2 by way of the headphone HP2 of the listener U2.

Likewise, the headphone HP3 correction section 64 adjusts the medium to high band signal of the down-mixed signal DMS for two channels so as to make it show gains and filter characteristics (of the equalizer, the low pass filter and so on) and a delay that suitably correspond to the distance from the subwoofer 3 to the listener U3 using the headphone HP3 by way of the HP3 gain adjusting circuit 64A, HP3 filter 64B and HP3 delay adjusting circuit 64C and also adjusts the sound pressure level by way of the HP3 power amplifier 64D. Then, it outputs the medium to high tones of the multichannel audio contents in two channels from the speaker units SU1 and SU2 by way of the headphone HP3 of the listener U3.

Thus, the bass-management-applied multichannel reproduction system 70 adjusts the medium to high band component signals of the down-mixed signal DMS for two channels to make it show gains and filter characteristics (of the equalizer, the low pass filter and so on) and a delay that suitably correspond to the distances from the subwoofer 3 to the listeners U1 through U3 using the headphones HP1 through HP3 respectively by means of the headphone HP1 correction section 62 through the headphone HP3 correction section 64 for the headphones HP1 through HP3 and then outputs the medium to high tones of the multichannel audio contents by way of the headphones HP1 through HP3 of the listeners U1 through U3. Thus, it is possible to give a comfortable feeling of direction of sound image to all the listeners U1 through U3.

Meanwhile, the multichannel reproduction system 70 makes all the listeners U1 through U3 listen to low tones that are not related to directionality from the subwoofer 3 so that all the listeners U1 through U3 can satisfactorily listen to low tones not only by way of their ears but also by way of their entire bodies.

Additionally, the multichannel reproduction system 70 can make only the subwoofer 3 output low tones and the headphones HP1 through HP3 output not any low tones but only medium to high tones so as to prevent any interference that can take place when medium to high tones are output from the speakers from occurring because bass management is applied to it.

While the speaker units SU1 through SU6 of the headphones HP1 through HP3 of this bass-management-applied multichannel reproduction system 70 are small sized speakers, the system can prohibit the small sized speakers from outputting low tones and allow only the subwoofer 3 to output low tones as a result of applying the idea of bass management so that it is possible to prevent output distortions and destruction of any of the speaker units SU1 through SU6 from taking place.

### (1-6) Operations and Advantages of the First Embodiment

With the multichannel reproduction systems 40, 50, 60 and 70 having the above-described respective configurations, all the listeners U1 through U3 employ not stand-alone type speakers but headphones HP1 through HP3 to listen to the medium to high tones of multichannel audio contents regardless of their listening positions. Thus, it is possible to remarkably reduce the energy of sounds leaking to the surroundings and hence the propagation of sounds to the surroundings due to the use of the headphones HP1 through HP3.

Additionally, with the multichannel reproduction systems 40, 50, 60 and 70, the gain and the filter characteristics (of the equalizers and the low pass filters) and the delays are adjusted to suitable levels, taking the distances from the subwoofer 3 to the listeners U1 through U3 into consideration, before the medium to high tones of the reproduced multichannel audio contents are provided to the listeners U1 through U3 individually listening to the contents by way of the headphones HP1 through HP3 so that it is possible to make the listeners U1 through U3, who are listening to the medium to high tone of the multichannel audio contents by way of the headphones HP1 through HP3, sense the sound image that the contents producer intended to produce.

At the same time, with the multichannel reproduction systems 40, 50, 60 and 70, the low tones of the multichannel audio contents are provided to the listeners U1 through U3 commonly by way of the subwoofer 3 so that all the listeners can listen to the low tones by means of the auditory sense and also feel the vibrations of the low tones by means of the tactile sense of all the body. Thus, the listeners U1 through U3 can satisfactorily feel the appeal of the vibrations of the low tones propagating through the body.

Additionally, with the multichannel reproduction systems 40, 50, 60 and 70, the gains, the filter characteristics (of the equalizers and the low pass filters) and the delays are adjusted and preset to suitable levels, taking the distances from the subwoofer 3 to the listeners U1 through U3 into consideration, before the medium to high tones of the reproduced multichannel audio contents are provided to the listeners U1 through U3 individually listening to the contents by way of the headphones HP1 through HP3. Thus, the low tones output from the subwoofer 3 and the medium to high tones output from the headphones HP1 through HP3 are smoothly linked to each other so that it is possible to provide a feeling of optimum sound image to all the listeners regardless of their listening positions.

Then, as a result, with the multichannel reproduction systems 40, 50, 60 and 70, it is possible to prevent in advance a phenomenon where the listener can hear only either of the low tones output from the subwoofer 3 and the medium to high tones output from the headphones HP1 through HP3, a phenomenon where the listener hears the two types of reproduced sounds as two isolated types of sounds, a (dip) phenomenon where the sound level of a specific frequency band of the reproduction band dips and becomes inaudible and/or a (peak) phenomenon where the sound level of a specific frequency band rises abruptly, all of which give a strange feeling to the listeners, from arising.

Thus, with the above-described arrangement, the multichannel reproduction systems 40, 50, 60 and 70 minimize sound leaks to the environment and provide a feeling of optimum sound image to all the listeners U1 through U3 regardless of their listening positions so that the listeners can listen to reproduced sounds of the highest quality.

### (2) Second Embodiment

Now, the second embodiment of the multichannel reproduction system will be described below.

### (2-1) Overall Configuration of Multichannel Reproduction System of the Second Embodiment

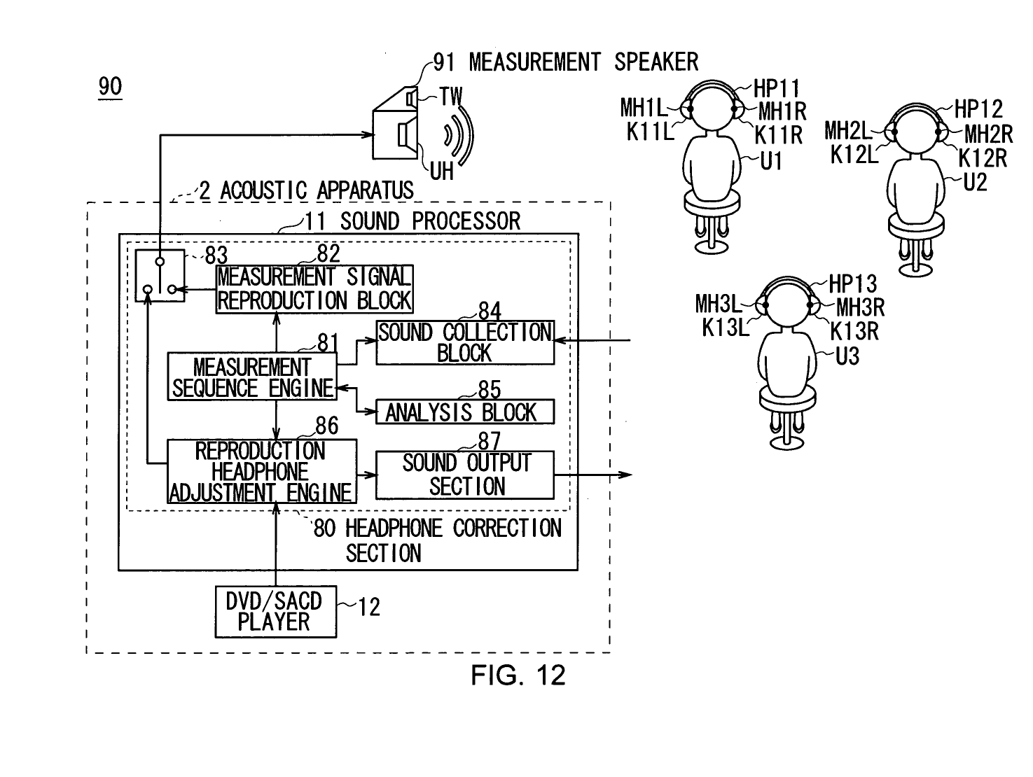

Referring to FIG. 12, in which the components similar to those of FIG. 1 are denoted respectively to the same reference symbols, 90 generally denotes the multichannel reproduction system of the second embodiment which is designed to provide multichannel audio contents to one or more listeners U1 through U3 in a living room or in some other home environment from a DVD, a SACD or the like with concert hall presence. The multichannel reproduction system 1 includes an acoustic apparatus 2 that is formed by using a sound processor 11 and a DVD/SACD player 12, a measurement speaker 91 to be used commonly for a plurality of users U1 through U3 staying at arbitrarily selected respective listening positions and non-closed type headphones HP11 through HP13 that the plurality of listeners U1 through U3 respectively use.

The multichannel reproduction system 90 has a headphone correction section 80 arranged in the sound processor 11 and having a Central Processing Unit (CPU) or a Digital Signal Processor (DSP) and outputs low measurement tones by means of a woofer UH of a measurement speaker 91 from a measurement signal reproduction block 82 by way of a switching circuit 83 under the control of a measurement sequence engine 81 in a measurement mode.

The headphone HP11 that the user U1 wears collects the low measurement tones by means of microphones MH1L, MH1R fitted respectively to cabinet sections K11L, K11R thereof and the headphone HP12 that the user U2 wears collects the low measurement tones by means of microphones MH2L, MH2R fitted respectively to cabinet sections K12L, K12R thereof, whereas the headphone HP13 that the user U3 wears collects the low measurement tones by means of microphones MH3L, MH3R for noise-canceling fitted respectively to cabinet sections K13L, K13R thereof.

The multichannel reproduction system 90 outputs medium to high measurement tones from a reproduction headphone adjustment engine 86 by way of an audio output block 87 and the headphones HP11 through HP13 and collects them by means of the microphones MH1L, MH1R of the headphone HP11, the microphones MH2L, MH2R of the headphone PH12 and the microphones MH3L, MH3R of the headphone PH13.

The measurement sequence engine 81 of the headphone correction section 80 has a sound collection block 84 collect the results of measurement of the low measurement tones and also the results of measurement of the medium to high measurement tones transmitted from the headphones HP11 through HP13 by wired or wireless transmission.

The measurement sequence engine 81 then has an analysis block 85 analyze the results of measurement of the low measurement tones to recognize how the low measurement tones are heard at each of the listening positions of the headphones HP11 through HP13 and computationally determine the suitable delays, taking the respective distances from the measurement speaker 91 to the listening positions of the users U1 through U3 into consideration.

Additionally, the measurement sequence engine 81 has the analysis block 85 analyze the results of measurement of the medium to high tones to recognize how the medium to high measurement tones are heard at each of the listening positions of the headphones HP11 through HP13 and computationally determine the gains, the filter characteristics (of the equalizer, the low pass filter and so on) of each of the headphones, taking the respective distances from the measurement speaker 91 to the listening positions of the users U1 through U3 into consideration.

Then, the measurement sequence engine 81 sends out theses various parameters (delays, gains and filter characteristics) to the reproduction headphone adjustment engine 86 and sets them in advance.

In a reproduction mode of operation, the reproduction headphone adjustment engine 86 of the headphone correction section 80 executes an arithmetic process on the audio signals of the multichannel audio contents supplied from the DVD/SACD player 12, using the various parameters for the delays, the gains and the filter characteristics (of the equalizer, the low pass filter and soon) of each of the headphones, and outputs the medium to high band component signals and the low band component signals that are obtained as a result to the headphones HP11 through HP13 of the users U1 through U3 by way of the audio output block 87 and to the woofer UH of the measurement speaker 91 by way of the switching circuit 83 respectively.

As a result and like the first embodiment, the multichannel reproduction system 90 can automatically provide the listeners U1 through U3 listening to the reproduced sounds of the multichannel audio contents by means of the headphones HP11 through HP13 with the sound images exactly according to the contents' producers intention so that the listeners U1 through U3 can listen to the low tones of the multichannel audio contents by way of the woofer UH of the measurement speaker 91 that is common to all the listeners U1 through U3 by means of the auditory sense and also feel the vibrations of the low tones by means of the tactile sense of all the body. Thus, the listeners U1 through U3 can satisfactorily feel the appeal of the vibrations of the low tones propagating through the body.

In this multichannel reproduction system 90, the medium to high tones of the reproduced sounds of the multichannel audio contents are adjusted for the gains, the filter characteristics (of the equalizers and the low pass filters) and the delays to suitable levels, taking the distances from the measurement speaker 91 to the listeners U1 through U3 into consideration, before the medium to high tones of the reproduced multichannel audio contents are provided to the listeners U1 through U3 individually listening to the contents by way of the headphones HP1 through HP3. Thus, the low tones output from the woofer UH of the measurement speaker 91 and the medium to high tones output from the headphones HP11 through HP13 are smoothly linked to each other so that it is possible to provide a feeling of optimum sound image to all the listeners regardless of their listening positions.

Then, as a result, with the multichannel reproduction system 90, it is possible to prevent in advance a phenomenon where the listener can hear only either of the low tones output from the woofer UH of the measurement speaker 91 and the medium to high tones output from the headphones HP1 through HP3, a phenomenon where the listener hears the two types of reproduced sounds as two isolated types of sounds, a (dip) phenomenon where the sound level of a specific frequency band of the reproduction band dips and becomes inaudible and/or a (peak) phenomenon where the sound level of a specific frequency band rises abruptly, all of which give a strange feeling to the listeners, from arising.

Note that the measurement speaker 91 of the multichannel reproduction system 90 may be replaced by a subwoofer 3 in a reproduction mode so that the low tones of the multichannel audio contents are output from the subwoofer 3.

### (2-2) Configuration of Headphone of the Second Embodiment

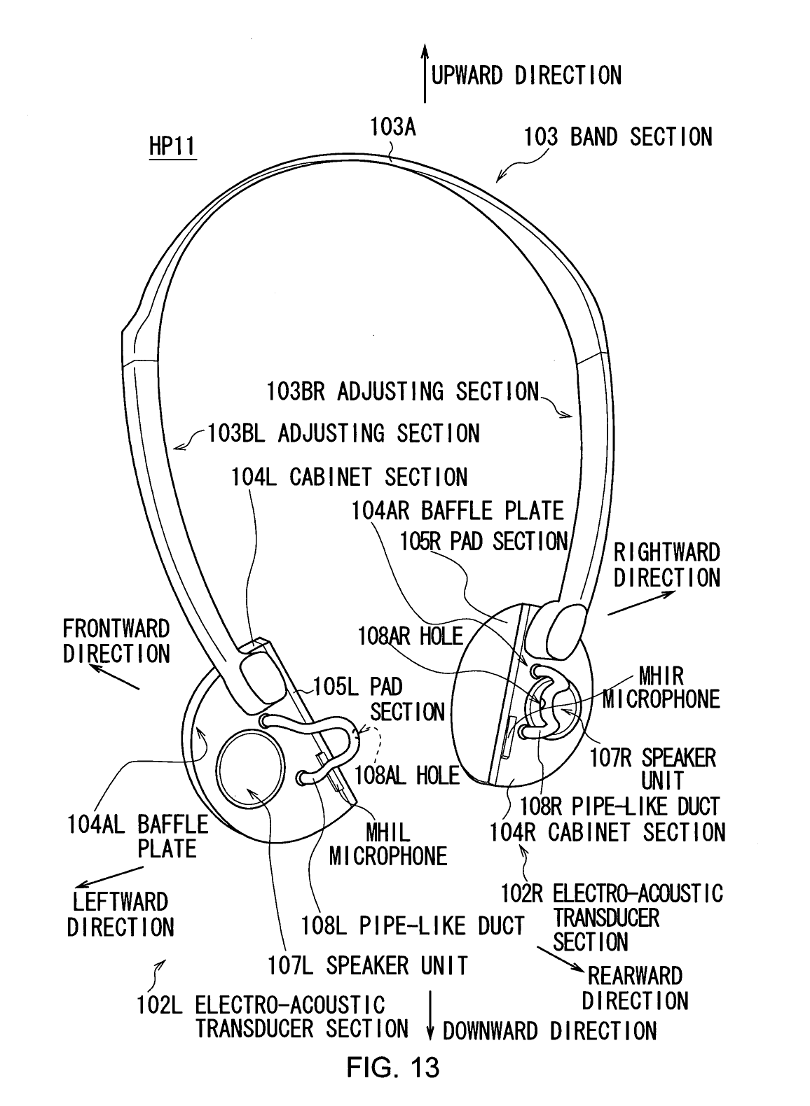

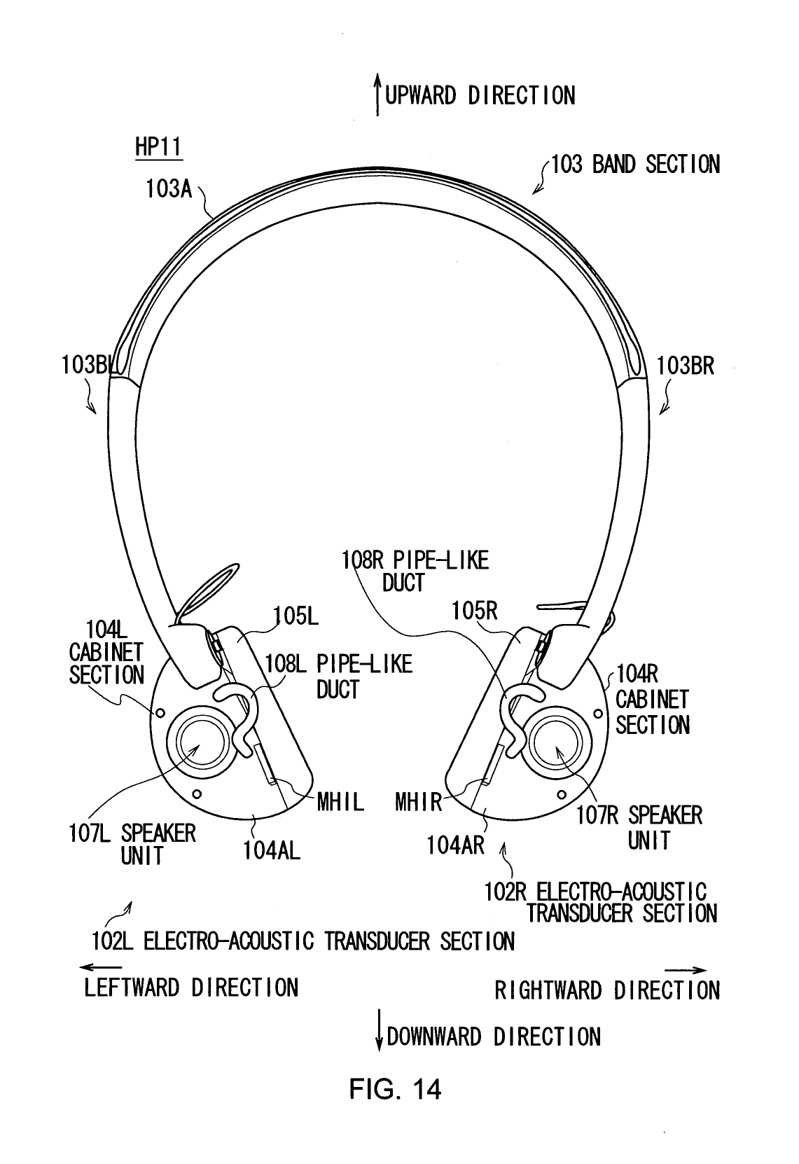

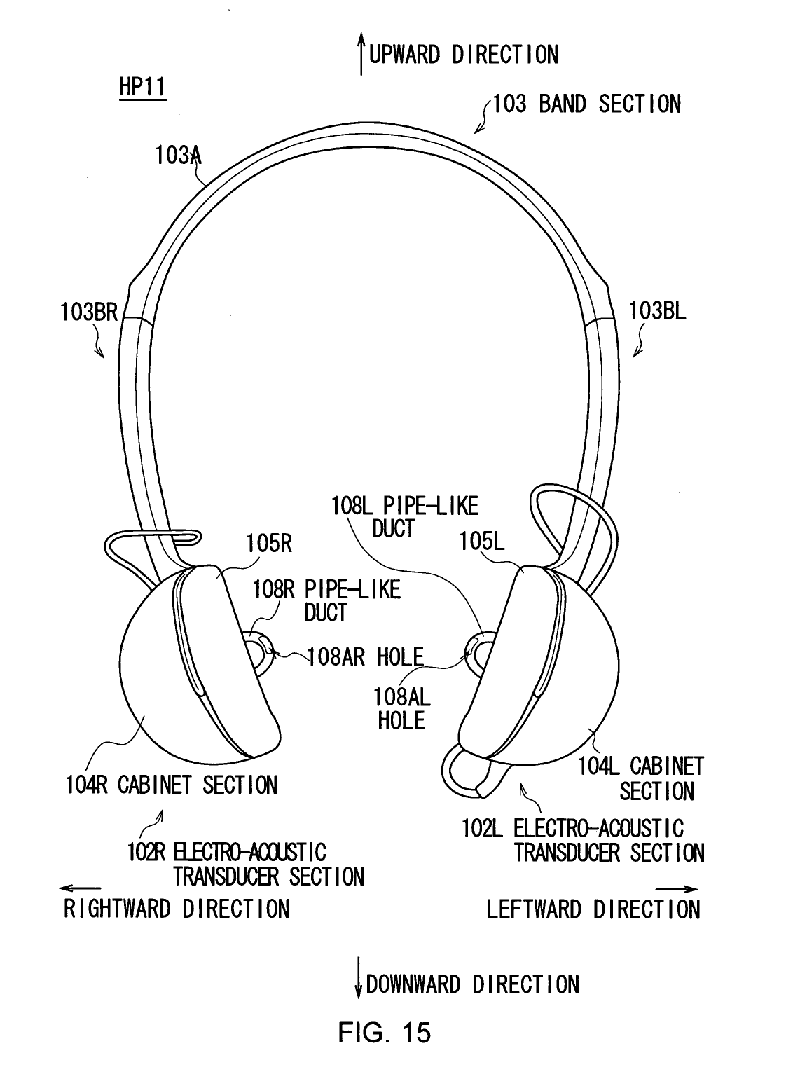

Each of the headphones HP11 through HP13 that are used in this multichannel reproduction system 90 may be structurally of an ear speaker type having two speaker units SU1 and SU2 to be arranged respectively in front of the left and right ears as shown in any of FIGS. 13 through 15. Since the headphones HP11 through HP13 are structurally identical, only the headphone HP11 will be described below for the purpose of convenience.

More specifically, it is assumed that the headphone HP11 is put on to the head of the listener just like an ordinary headphone and unlike any ordinary cabinet type speaker. It roughly includes electro-acoustic transducer sections 102L and 102R for converting audio signals into reproduced sounds and a band section 103 for fitting and rigidly anchoring the electro-acoustic transducer sections 102L and 102R to the head of the listener U1.

The electro-acoustic transducer sections 102L and 102R are arranged around respective cabinet sections 104L and 104R operating as centers, each having a profile produced by equally dividing a ball into four parts in a vertical direction. Each of the cabinets sections 104L and 104R has a rear surface side flat section and lateral inner side flat sections. The lateral inner side flat sections of the cabinet sections are provided with respective pad sections 105L and 105R for buffering the lateral pressure applied to the head of the listener U1.

Speaker units 107L and 107R for converting the audio signals of the multichannel audio contents into reproduced sounds and noise-canceling microphones MH1L and MH1R are fitted respectively to the rear surface side flat sections of the cabinet sections 104L and 104R that operate as baffle plates 104AL and 104AR.

More specifically, the noise-canceling microphones MH1L and MH1R are arranged at respective positions located closer to the external auditory meatus of the listener U1 than the speaker units 107L and 107R in order to enhance the noise-canceling effect of the headphone H11.

The speaker units 107L and 107R are designed to vibrate their respective diaphragms to emit sounds according to the audio signals of the multichannel audio contents supplied thereto from the audio output block 87 (FIG. 12) by wired or wireless transmission.

Pipe-like ducts 108L and 108R formed respectively by bending hollow members having a predetermined diameter to show a substantially U-shaped lateral view are fitted to the baffle plates 104AL and 104AR of the cabinet sections 104L and 104R.

The pipe-like ducts 108L and 108R are bent inwardly at the rear ends thereof and provided respectively with holes 108AL and 108AR substantially at the middle points of the top part of the rear end side thereof.

The band section 103 is made to show a substantially standing arch-shaped profile with a middle part section 103A located at the top so as to match the head profile of ordinary persons and the overall length of the headphone HP11 can be adjusted by means of left and right adjusting sections 103BL and 103BR that can slide and become extended or contracted relative to the middle part section 103A.

More specifically, the band section 103 is made to show a substantially standing arch-shaped profile that is smaller than the head profile of ordinary persons and have a certain degree of resiliency so that, as it is put on by the listener U1, moving the cabinet sections 104L and 104R laterally outwardly to extend them, the worn headphone HP11 tends to restore the original profile due to the resiliency thereof so that it is fitted to the head of the listener U1 with the cabinet sections 104L and 104R held in contact with the head of the listener U1.

Since the headphone H11 is substantially laterally symmetrical as shown in FIGS. 13 through 15, the left side electro-acoustic transducer section 102L will be mainly described below.

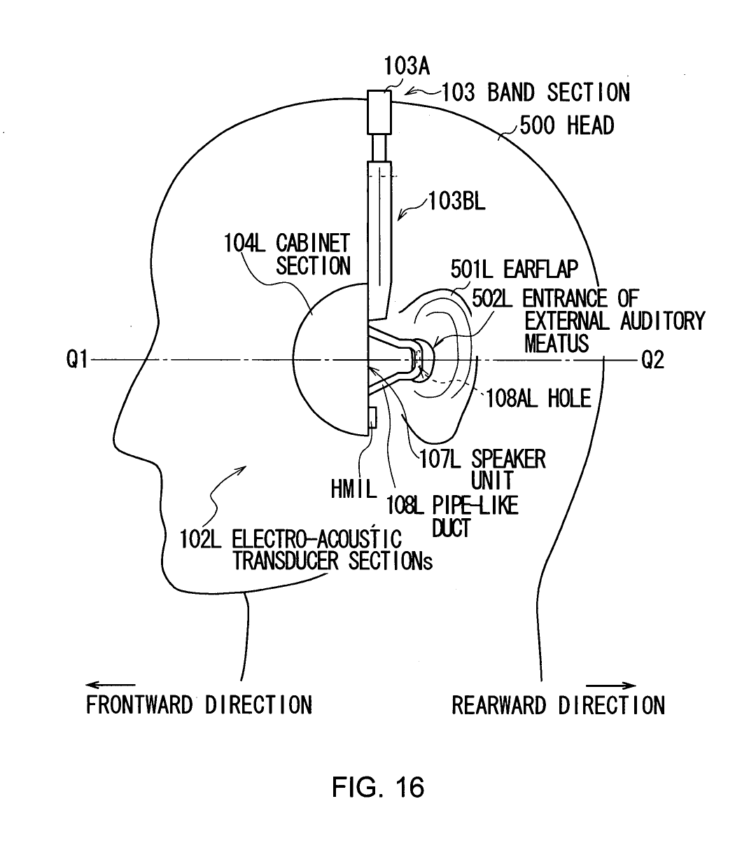

In actuality, as the band section 103 is adjusted for the length thereof and the headphone HP11 is put on by the listener U1 at the head 500 as shown in FIG. 16, which illustrates the left lateral side of the head 500, the electro-acoustic transducer section 102L arranged at the lower end side of the adjusting section 103BL is located slightly forwardly relative to the left earflap 501L of the head 500 of the listener U1.

Then, as a result, the electro-acoustic transducer section 102L of the headphone HP11 causes the medium to high tones emitted from the speaker unit 107L to directly get to the inside of the left external auditory meatus of the left ear of the listener U1 and, at the same time the reflected sounds reflected by the left cheek, the left earflap 501L and so on also get to the inside of the left external auditory meatus of the left ear so that it is possible to give rise to natural sound image localization as in the case of listening to medium to high tones by way of an ordinary stand-alone type speaker.

Thus, as the headphone HP11 is put on properly by the listener U1, the speaker unit 107L is located slightly forwardly relative to the earflap 501L and the entrance 502L of the left external auditory meatus and the hole 108AL of the pipe-like duct 108L is located near the entrance 502L of the left external auditory meatus.

Note that the pipe-like duct 108L has a substantially U-shaped lateral view and hence does not get into the external auditory meatus of the listener U1. Thus, the headphone HP11 can prevent the pike-like duct 108L from damaging the inside of the external auditory meatus by error when the listener U1 puts on the headphone HP11.

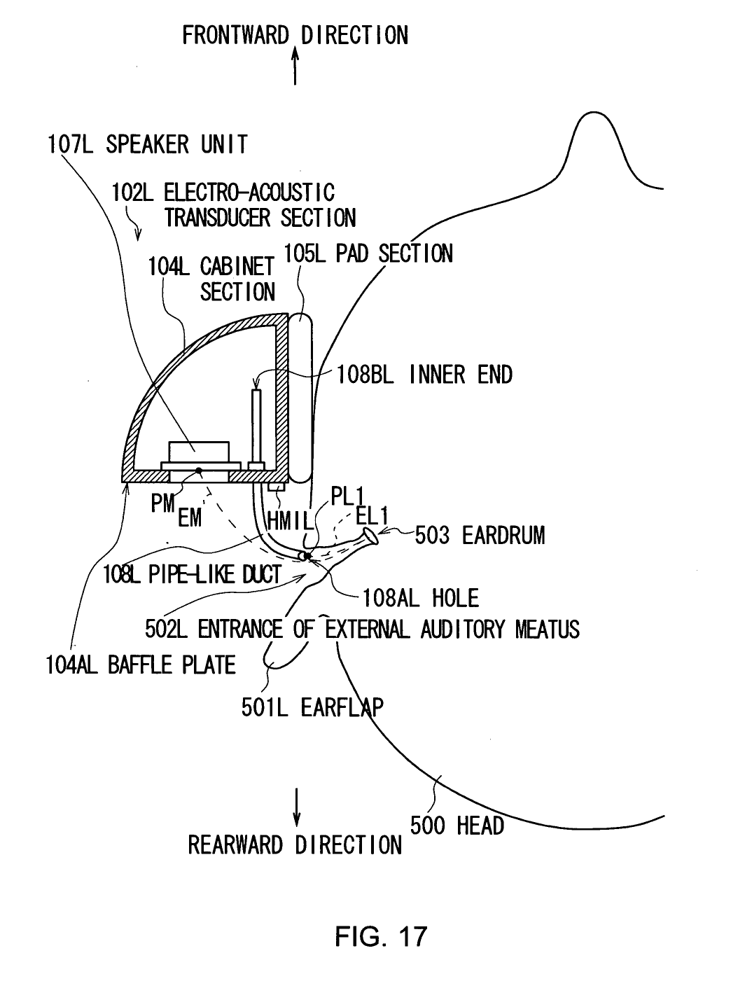

The cabinet section 104L contains a closed space except the pipe-like duct 108L with the speaker unit 107L fitted thereto as seen from the cross sectional view of FIG. 17 that is taken along line Q1-Q2 in FIG. 16 so that the cabinet section 104L and the pipe-like duct 108L form a resonance circuit for the speaker unit 107L.

The pipe-like duct 108L runs through the baffle plate 104AL of the cabinet section 104 from the inside of the cabinet section 104L and gets to a position near the entrance 502L of the external auditory meatus of the listener U1. In fact, the electro-acoustic transducer section 102L operates as a bass reflex type speaker as a whole as the pipe-like duct 108L is made to operate as bass reflex duct.

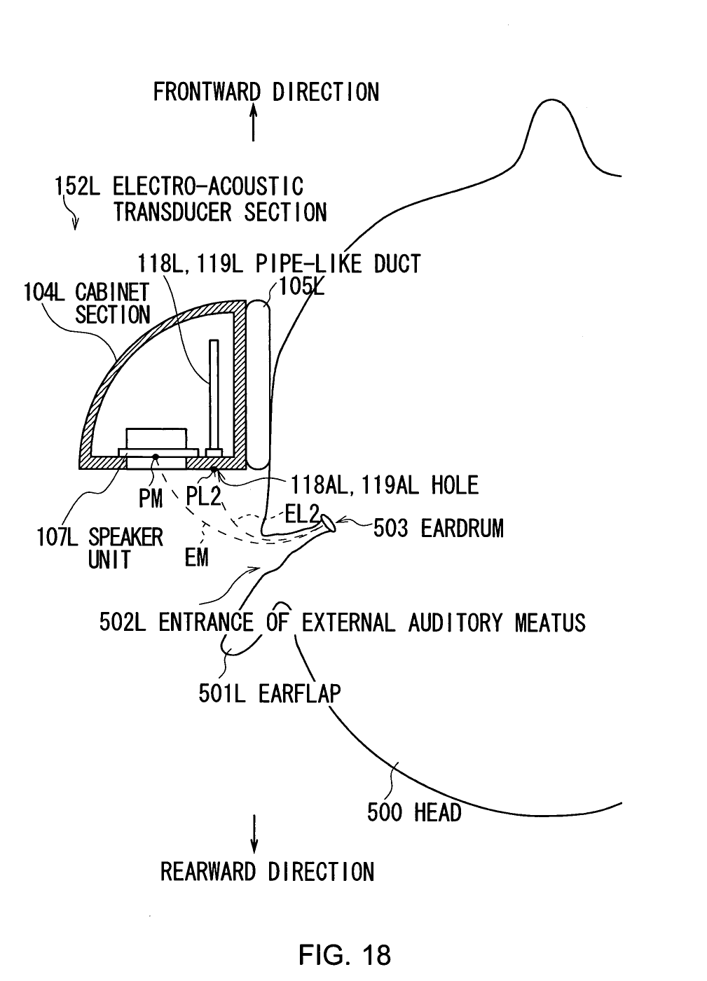

Meanwhile, only the duct is arranged in the inside and not extended to the outside of the cabinet section of an ordinary bass reflex type speaker. Assume an electro-acoustic transducer section 152L as shown in FIG. 18 so as to be compared with the electro-acoustic transducer section 102L of FIG. 17.

The electro-acoustic transducer section 152L has a configuration same as that of an ordinary bass reflex type speaker and includes a pair of pipe-like ducts 118L and 119L arranged only in the inside of the cabinet section 104 instead of the pipe-like duct 108L of the electro-acoustic transducer section 102L.

In the case of the electro-acoustic transducer section 152L, when the position of the speaker unit 107L is regarded as the position PM of a virtual sound source (to be referred to as virtual sound source position hereinafter) and the route length EM of the medium to high tones emitted from the speaker unit 107L until they get to the left eardrum 503L of the listener U1 is compared with the route length EL2 of the low tones transmitted through the inside of the pipe-like ducts 118L and 119L and emitted from the holes 118AL and 119A until they get to the left eardrum 503L of the listener U1, the relationship of the route length EM≈EL2 holds true.

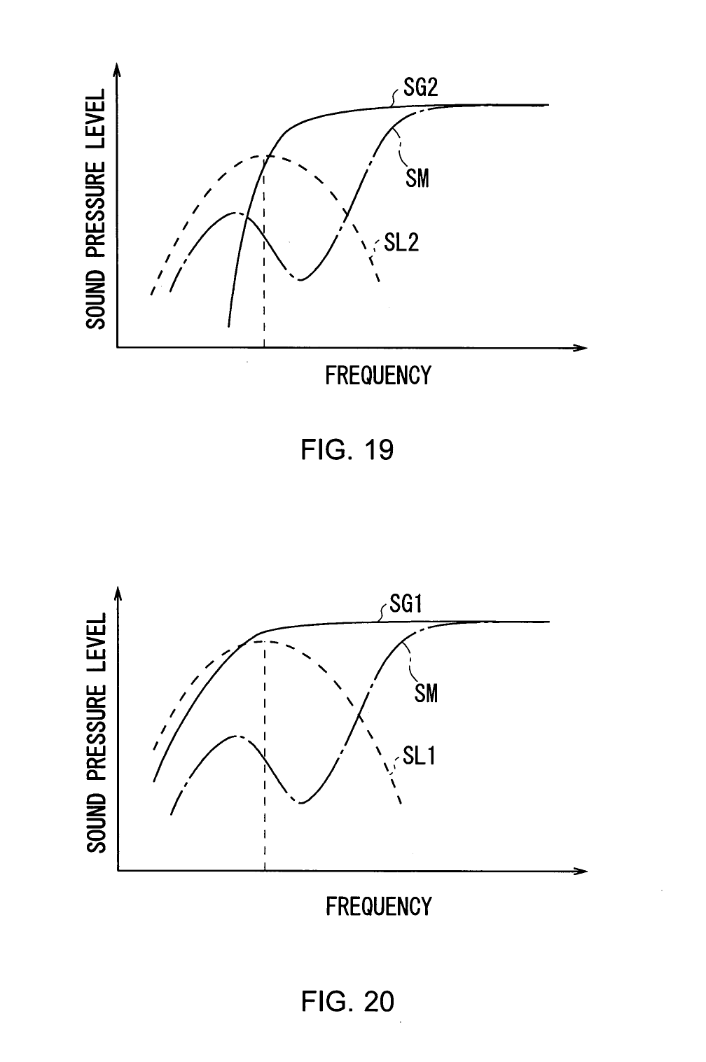

FIG. 19 is a graph illustrating the frequency characteristics of the sounds that are caused to get to the left eardrum 503L by the conventional electro-acoustic transducer section 152L. As shown in FIG. 19, the medium to high tones emitted from the speaker unit 107L to show the frequency characteristic as indicated by characteristic curve SM and the low tones transmitted through the inside of the pipe-like ducts 118L and 119L and emitted from the holes 118AL and 119AL to show the frequency characteristic as indicated by characteristic curve SL2 are put together and then caused to get to the left eardrum 503L of the listener U1.

With this arrangement, the electro-acoustic transducer section 152L can cause the reproduced sounds to be heard by the listener U1 and, in the reproduced sounds, the sound pressure level of the low band indicated by characteristic curve SM is raised to a certain extent as seen from characteristic curve SG2 that is formed by synthetically combining the characteristic curve SM and the characteristic curve SL2.

With the electro-acoustic transducer section 102L (FIG. 17) according to the embodiment of the present invention, on the other hand, when the position of the speaker unit 107L is regarded as the virtual sound source position PM and the route length EM of the medium to high tones emitted from the speaker unit 107L until they get to the left eardrum 503L of the listener U1 is compared with the route length EL1 of the low tones transmitted through the inside of the pipe-like duct 108L and emitted from the hole 108AL until they get to the left eardrum 503L of the listener U1, the relationship of the route length EM>EL1 holds true.

FIG. 20 is a graph illustrating the frequency characteristics of the sounds that are caused to get to the left eardrum 503L by the electro-acoustic transducer section 152L according to the embodiment of the present invention. As shown in FIG. 20 and as in the case of FIG. 19, the medium to high tones emitted from the speaker unit 107L to show the frequency characteristic as indicated by characteristic curve SM and the low tones transmitted through the inside of the pipe-like duct 108L and emitted from the hole 108AL to show the frequency characteristic as indicated by characteristic curve SL1 are put together and then caused to get to the left eardrum 503L of the listener U1.

Generally, the distance from a sound source and the sound pressure level of the sound show an inversely proportional relationship. When the route length of the electro-acoustic transducer section 102L (FIG. 17) and that of the electro-acoustic transducer section 152L (FIG. 18) are compared, they show a relationship of the route length EL1<the route length EL2.

In other words, the electro-acoustic transducer section 102L (FIG. 17) is located at a position closer to the meatus acoustic externus entrance 502L of the listener U1 than the electro-acoustic transducer section 152L (FIG. 18), the low tones transmitted through the inside of the pipe-like duct 108L and emitted from the hole 108AL (virtual sound source position PL1) can be made to get to the left eardrum 503L with a sound pressure level higher than the low tones of the electro-acoustic transducer section 152L.

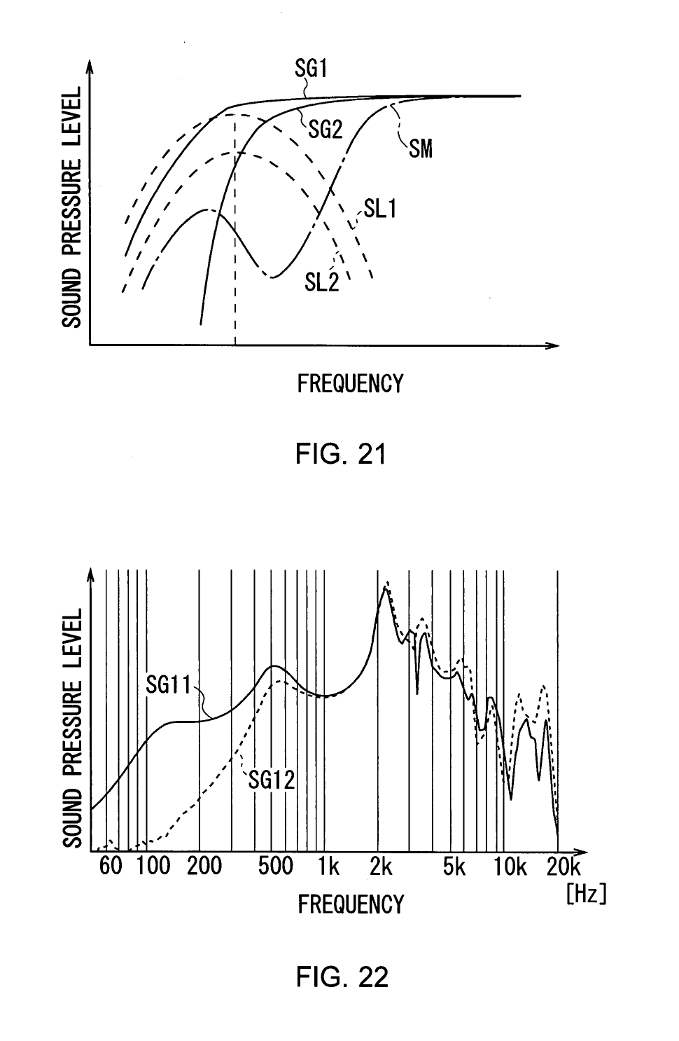

As seen from the characteristic curves shown again in FIG. 21, the characteristic curve SL1 of the low tones produced by the pipe-like duct 108L shows a sound pressure level higher than the characteristic curve SL2 of the low tones produced by the pipe-like ducts 118L and 119L due to the relationship of the route length EL1<the route length EL2 as a whole.

Then, as a result, the electro-acoustic transducer section 102L can cause the listener U1 to listen to reproduced sounds down to a relatively low frequency band with a sufficiently high sound pressure level that is raised from the sound pressure level of the low tones of the electro-acoustic transducer section 152L (characteristic curve SG2) for the characteristic curve SM as indicated by the characteristic curve SG1 formed by synthetically combining the characteristic curve SM and the characteristic curve SL1.

By comparing the characteristic curve SG1 and the characteristic curve SG2, it will be seen that the sound pressure level of the characteristic curve SG2 falls relatively sharply as the curve approaches the low frequency band side, whereas that of the characteristic curve SG1 falls only mildly as the curve approaches the low frequency band side.

Thus, if compared with the electro-acoustic transducer section 152L, the electro-acoustic transducer section 102L can transmit excellent reproduced sounds showing a high sound pressure level over a wide frequency band and containing a sufficiently wide low frequency band to the left eardrum 503 of the listener U1 for listening.

Note that, as shown in FIGS. 16 and 17, the low end side of the pipe-like duct 108L of the electro-acoustic transducer section 102L is located near the meatus acoustic externus entrance 502L and does not completely close the meatus acoustic externus entrance 502L.

Thus, the electro-acoustic transducer section 102L can cause the reproduced sounds obtained by combining the medium to high tones output from the speaker unit 107L and the low tones emitted from the hole 108AL of the pipe-like duct 108L to get to the left eardrum 503L of the listener U1 without intercepting the sounds generated around the listener U1 (to be referred to as surrounding sounds hereinafter).

Note that the electro-acoustic transducer section 102L is so specified that the cabinet section 104L has an inner capacity of 10 ml and the speaker unit 107L has an outer diameter of 21 m, while the diaphragm of the speaker unit 107L has an effective vibration diameter of 8.5 mm and the equivalent mass of the vibration system is 0.2 g. Additionally, it is so specified that the lowest resonance frequency f0 is 360 Hz and the resonance Q0 is 1.0.

Furthermore, the pipe-like duct 108L has an inner diameter of 1.8 mm and the effective length of the pipe-like duct 108L from the inner end 108BL thereof located in the inside of the cabinet section 104L to the hole 108AL is 50 mm, while the distance from the surface of the baffle plate 104AL to the hole 108Al is about 35 mm.

Since the hole 108AL is arranged at the middle point of the top part of the rear end side of the pipe-like duct 108L that shows a U-shaped lateral view, the upper half and the lower half of the pipe-like duct 108L actually form two bass reflex ducts. Therefore, the inner diameter and the effective length of the pipe-like duct 108L are determined by considering the inner diameter thereof (which corresponds to about 2.5 mm in this case) when reduced to a single pipe-like duct.

The frequency characteristics of the electro-acoustic transducer section 102L and those of the electro-acoustic transducer section 152L were observed by means of a measurement jig formed by mimicking the earflap and the meatus acoustic externus of man to obtain the characteristic curve SG11 (of the electro-acoustic transducer section 102L) and the characteristic curve SG12 (of the electro-acoustic transducer section 152L) as shown in FIG. 22.

In the case of the theoretical frequency characteristics of FIG. 21, the characteristic curve SG11 of the electro-acoustic transducer section 102L shows a high sound pressure level than the characteristic curve SG12 of the electro-acoustic transducer section 152L in the low frequency band not higher than about 500 Hz. Thus, the electro-acoustic transducer section 102L can actually cause the listener U1 to listen to good reproduced sounds satisfactorily containing low tones.

Thus, when the headphone HP11 is put on the head 500 of the listener U1, the speaker unit 107L is placed at a position slightly separated from the meatus acoustic externus entrance 502L of the listener U1 to emit medium to high tones, while the hole 108Al of the pipe-like duct 108L that is extended from the cabinet section 104L to near the meatus acoustic externus entrance 502L operates as bass reflex duct emits low tones of reproduced sounds so that it provides natural sound image localization and causes the listener U1 to listen to good reproduced sounds satisfactorily containing low tones.

### (2-3) Sound Image Localization Technique of the Second Embodiment

The sound image localization technique for the above-described ear speaker type headphones HP11 through HP13 is similar to the sound image localization for the headphones HP1 through HP3 respectively having a single speaker unit 107L to be placed at the lateral side of the left ear and a single speaker unit 107R to be placed at the lateral side of the right ear and hence will not be described any further here.

### (2-4) Specific Circuit Configuration of Noise-Canceling Function of the Second Embodiment

Now, the system configuration of this embodiment for realizing a noise-canceling function by means of the sound processor 11 of the multichannel reproduction system 90 of the second embodiment will be described below.

The noise-canceling process section for realizing the noise-canceling feature is arranged in the inside of the sound processor 11 apart from the above-described headphone correction section 80 (FIG. 12). The principle of general noise-canceling operation of the noise-canceling process section will be firstly described below.

Currently so-called noise-canceling systems are becoming popular as systems for actively reducing the external noise for headphones. Most of the systems that are being marketed are formed by using analog circuits and the noise-canceling techniques employed in such systems are roughly classified into the feedback type and the feed-forward type.

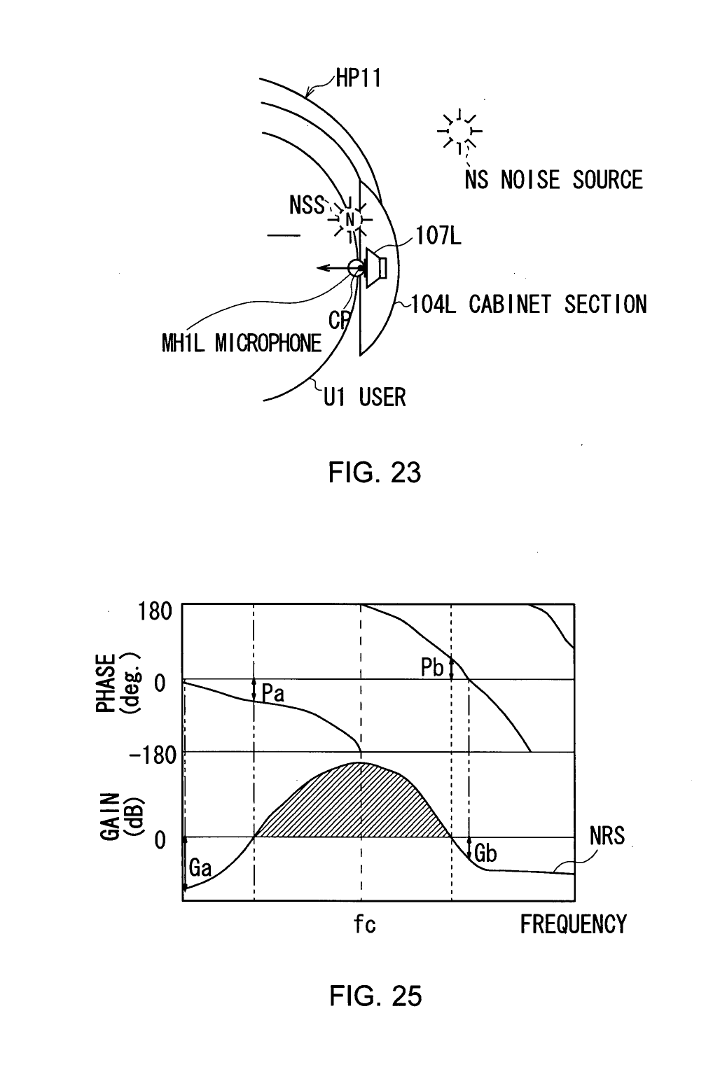

With the feedback technique, generally a microphone MH1L is arranged in the inside of the cabinet section 0 (housing section) 104L of the headphone HP11 as shown in FIG. 23 and anti-phase component data are generated for the noise data on the external noise NSS collected by the microphone MH1L. Then, a noise-canceling sound that corresponds to the anti-phase component data is output from the speaker unit 107L by servo control in order to attenuate the external noise NSS invading the cabinet section 104L.

In this case, the position where the microphone MH1L is arranged operates as noise-canceling control point CP. Therefore, the microphone MH1L is actually placed at a position closest to the ear of the listener U1, or near the front surface of the diaphragm of the speaker unit 107L, in order to maximize the noise attenuation effect.

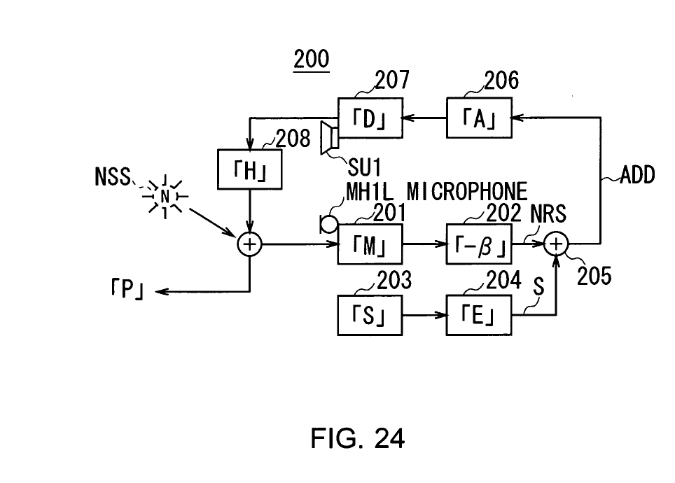

As shown in FIG. 24, the feedback type noise-canceling system 200 realized by applying the above-described noise-canceling principle collects external noise NSS by means of the microphone MH1L and the obtained noise data is amplified to a predetermined level by means of a microphone amplifier 201 as a function of the external noise NSS and then sent out to a feedback filter 202.

The feedback filter 202 generates noise reduction data NRS that is anti-phase relative to the noise data and amplifies the generated noise reduction data NRS to the amplitude level same as the noise data by means of a power amplifier 206 before it outputs a noise-canceling sound that matches the noise reduction data NRS from the speaker unit 107L by way of a driver 207.

As a result, the external noise NSS and the noise-canceling sound are added at the noise-canceling control point CP so that consequently the sounds of the multichannel audio contents are output from the headphone HP11 with the external noise NSS offset by the noise-canceling sound.

On the other hand, the noise-canceling system 200 is designed to adjust the audio data S of the multichannel audio contents from the sound source 203 to make them show acoustic characteristics desired by the listener by way of an equalizer 204 before they are sent out to an adder circuit 205.

Thus, the adder circuit 205 adds the noise reduction data NRS supplied from the feedback filter 202 and the audio data S of the multichannel audio contents and outputs the synthetically combined data ADD obtained as a result from the speaker unit 107L by way of the power amplifier 206 and the driver 207 so that consequently the listener U1 can listen to the sounds of the multichannel audio contents because the external noise NSS is eliminated by the offset.

Now, the transfer function of the power amplifier 206 is expressed as “A” and that of the driver 207 is expressed as “D”, while the transfer function of the microphone MH1L and the microphone amplifier 201 is expressed as “M” and that of the feedback filter 202 is expressed as “−β” here for the noise-canceling system 200.

Similarly, the transfer function of the equalizer 204 by which the audio data S of the multichannel audio contents output from the sound source 203 is expressed as “E” and the space transfer function 208 from the driver 207 to the microphone MH1L where the noise-canceling control point CP is located is expressed as “H”. Assume that all the transfer functions are expressed by complex representations. Additionally, the external noise NSS is expressed as “N” and the sound pressure of the reproduced sounds that gets to the listener U1 is expressed as “P”.

External noise NSS typically gets into the cabinet section 104L of the headphone HP11 when it leaks into the cabinet section 104L through the gap of the pad section 105L of the cabinet section 104L under sound pressure and when the cabinet section 104L is forced to vibrate by the sound pressure so that consequently the noise is transmitted into the inside of the cabinet section 104L.

Then, the sound pressure “P” of the reproduced sounds output from the speaker unit 107L of the headphone HP11 can be expressed by formula (1) shown below.

[formula 1]

$$P = \frac{1}{1 + A D H M β} N + \frac{A H D}{1 + A D H M β} E S \qquad ( 1 )$$

It will be seen by paying attention to the term of “N” of the above formula (1) that the external noise NSS is attenuated to “1/(1+ADHMβ) which operates as coefficient part for “N”. For the system of the formula (1) not to oscillate but to operate stably, it is necessary that formula (2) shown below holds true.

[formula 2]

$$\vert \frac{1}{1 + A D H M β} \vert < 1 \qquad ( 2 )$$

Considering that generally “1<<|ADHMβ|”, the formula (2) can be interpreted in a manner as described hereinafter.

In the noise-canceling system 200 of FIG. 24, the total transfer function “−ADHMβ” for the loop part relating to “N” that corresponds to the external noise NSS of the feedback loop is referred to as open-loop. FIG. 25 shows a Bode diagram that illustrates the characteristics of the open-loop.

The Bode diagram illustrates that the gain is maximized at frequency fc and the phase is shifted by 180° so that the noise reduction signal NRS generated by the open-loop at this point shows the greatest noise-canceling effect.

In other words, for the noise-canceling effect to be really effective, it is necessary that two requirements are satisfied, the two requirements including that both gain Ga and gain Gb should be smaller than 0 dB when the point of phase 0 deg. is passed and hence when the noise reduction data NRS is in phase with the noise data that corresponds to the external noise NSS and that the point of phase 0 deg. is not included and phase Pa or phase Pb that is shifted from phase 0 deg. should be reached when the gains are not less than 0 dB.

Positive feedback takes place to give rise to oscillations (howling) in the noise-canceling system 200 when the requirements are not satisfied.

The gain Ga and the gain Gb are gain margins for not giving rise to oscillations. Similarly, the phase Pa and the phase Pb are phase margins for not giving rise to oscillations. When the gain margins and the phase margins are small, the risk of giving rise to oscillations rises depending on the variance that can arise depending on the individual listener and the way in which the listener puts on the headphone HP11.

Since the requirements relating to oscillations are determined by the total transfer function “−ADHMβ”, the transfer function “−β” of the feedback filter 202 is defined by taking the characteristics into consideration and the resistance against oscillations (howling) of the individual listener is raised by increasing the gain margins and the phase margins as much as possible.

Now, the operation of reproducing the sounds of the audio data S of the multichannel audio contents from the sound source 203 from the headphone HP11, using the above-described noise-canceling feature, will be described below.

While the audio data “S” refer to the sounds of the multichannel audio contents from the sound source 203 here, they cover all the sounds including those collected by the microphone MH1L at the cabinet 104 (when the microphone MH1L is used as hearing aid) and those received by way of telecommunication (when the microphone MH1L is used as head set) in the proper sense of the words.

Now, attention is paid to the term of audio data S in the above formula (1) and the transfer function “E” of the equalizer 204 is defined so as to make formula (3) below hold true:

[formula 3]

E=(1+ADHMβ) (3)

Then, as the right side of the above formula (3) is used as substitute in the formula (1), the formula (1) is expressed to read as formula (4) shown below.

[formula 4]

$$P = \frac{1}{1 + A D H M β} N + A H D S \qquad ( 4 )$$

When attention is paid to the term of audio data S in the above formula (4), it will be seen that characteristic similar to that of the ordinary headphone HP11 that does not have any noise-canceling feature is obtained as “H” is the transfer function of the distance from the speaker unit SU1 to the microphone MH1L and “A” is the transfer function of the power amplifier 206, while “D” is the transfer function of the driver 207.

Note that the characteristic of the equalizer 204 is similar to the characteristic (FIG. 25) of the total transfer function “−ADHMβ” of the open-loop as viewed from the axis of frequency.

Thus, when the equalizer 204 is defined by the above-described formula (3) and the sounds of the audio data S of the multichannel audio contents from the sound source 203 are reproduced from the headphone HP11, operating the noise-canceling feature, it is possible to output the sounds with the sound level similar to the sounds output from the headphone HP11 that does not have any noise-canceling feature.

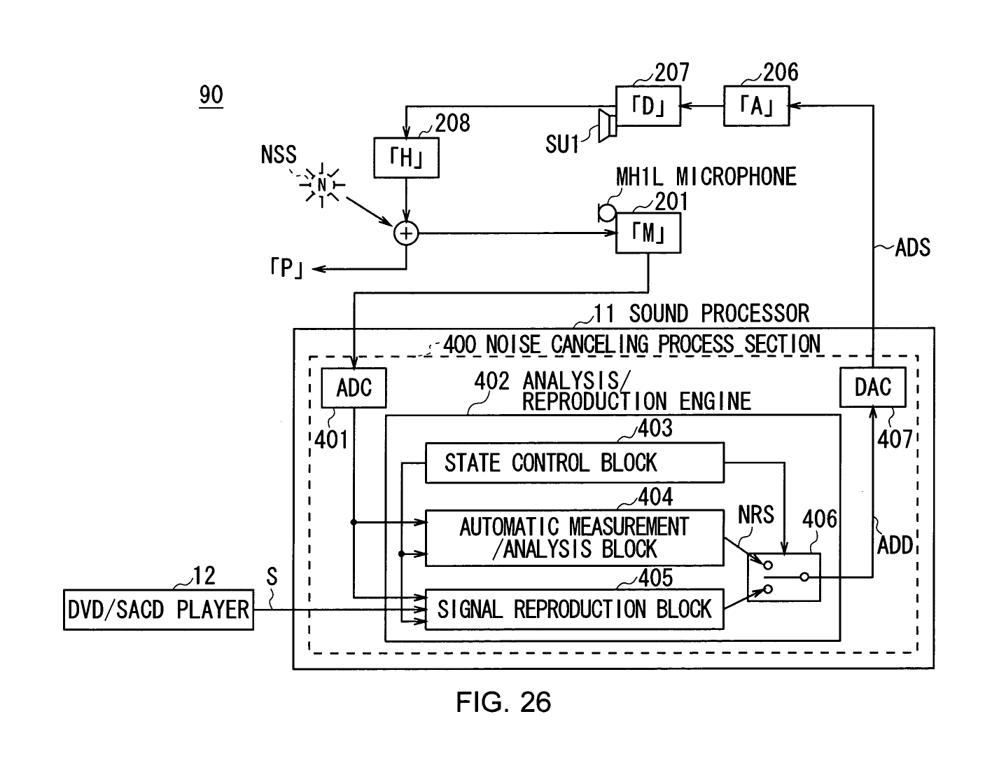

FIG. 26 is a schematic block diagram of the multichannel reproduction system 90 having a noise-canceling feature based on the concept of the above-described noise-canceling system 200. The components in FIG. 26 that correspond to those of FIG. 24 are denoted respectively by the same reference symbols. As shown in FIG. 26, the multichannel reproduction system 90 has a noise-canceling process section 400 formed by using a CPU or a DSP and arranged in the sound processor 11 in addition to the headphone correction section 80 (FIG. 12).

In the measurement mode, the multichannel reproduction system 90 collects the external noise NSS by means of the microphone MH1L and amplifies the noise signal that corresponds to the external noise NSS to a predetermined level by means of the microphone amplifier 201. Then, the multichannel reproduction system 90 sends out the amplified noise signal to the noise-canceling process section 400 of the sound processor 11.

The noise-canceling process section 400 operates for analog/digital conversion of the noise signal supplied from the microphone amplifier 201 by means of the analog/digital converter 401 and sends out the noise data obtained as a result to an analysis/reproduction engine 402 formed by using a CPU or a DSP.

The analysis/reproduction engine 402 collectively controls an automatic measurement/analysis block 404 and signal reproduction block 405 under the control of a state control block 403 and sends out the noise data supplied from the analog/digital converter 401 to the automatic measurement/analysis block 404.

The automatic measurement analysis block 404 analyzes the noise data and generates noise reduction data NRS that is anti-phase relative to the noise data. It executes the process of the feedback filter 202 and that of the equalizer 204 as described above by referring to FIG. 24 and stores the noise reduction data NRS obtained as a result of the execution.

Then, in the reproduction mode, the multichannel reproduction system 90 sends out the audio data S of the multichannel audio contents reproduced by the DVD/SACD player 12 that operates as the sound source 203 (FIG. 24) to the signal reproduction block 405 of the analysis/reproduction engine 402.

The signal reproduction block 405 defines the equalizer 204 (FIG. 24) as the above-described formula (3) and subjects the audio data S of the multichannel audio contents to an equalizing process by means of the equalizer 204 before it sends out the audio data S to a digital/analog converter 407 by way of a switching circuit 406.

Then, the automatic measurement analysis block 404 sends out the noise reduction data it computationally determined in the measurement mode to the digital/analog converter 407 by way of the switching circuit 406. The digital/analog converter 407 adds the noise reduction data NRS and the audio data S of the multichannel audio contents and generates synthetically combined signal ADS by executing an analog conversion process on the synthetically combined digital data ADD that is obtained as a result of the addition. Then, the digital/analog converter 407 outputs the synthetically combined signal ADS by way of the power amplifier 206 and the driver 207. It may alternatively be so arranged that the synthetically combined digital data ADD is output without passing through the digital/analog converter 407 by means of a so-called digital amplifier that directly drives the synthetically combined digital data ADD with power according to a recently developed technique.

Then, as a result, the multichannel reproduction system 90 digitally executes a noise-canceling process by way of the noise-canceling process section 400 of the sound processor 11 and can have the listener U1 listen to the clear multichannel audio contents from which the external noise NSS is eliminated by an offset.

### (2-5) Operations and Advantages of the Second Embodiment

With the multichannel reproduction system 90 having the above-described configuration, all the listeners U1 through U3 employ not stand-alone type speakers but headphones HP1 through HP3 to listen to the medium to high tones of multichannel audio contents regardless of their listening positions. Thus, it is possible to remarkably reduce the energy of sounds leaking to the surroundings and hence the propagation of sounds to the surroundings due to the use of the headphones HP1 through HP3.

Additionally, the multichannel reproduction system 90 digitally adjusts the gain and filter characteristics (of the equalizer, the low pass filter and so on) so as to make them suitable for each listening position by collecting and analyzing the measured medium to high tones output from the headphones HP11 through HP13 by means of the microphones provided for the purpose of noise-canceling and has the listeners U1 through U3 individually listen to the medium to high tones of the multichannel audio contents by way of the respective headphones HP11 through HP13. Thus, it is possible to make the users U1 through U3 listening to the medium to high tones of the multichannel audio contents by means of the respective headphones HP11 through HP13 exactly sense the sound image that the contents producer intended to produce.

When the multichannel reproduction system 90 actually operates the noise-canceling feature, it is possible to make the listeners U1 through U3 optimally sense the sound image and clearly listen to the sounds of the multichannel audio contents that are free from any external noise NSS.

At the same time, with the multichannel reproduction system 90, the low tones of the multichannel audio contents are provided to the listeners U1 through U3 commonly by way of the woofer UH of the measurement speaker 91 that is common to all the listeners U1 through U3 so that all the listeners can listen to the low tones by means of the auditory sense and also feel the vibrations of the low tones by means of the tactile sense of all the body. Thus, the listeners U1 through U3 can satisfactorily feel the appeal of the vibrations of the low tones propagating through the body.

Additionally, with the multichannel reproduction system 90, the delays are automatically and digitally adjusted, taking the distances from the subwoofer UH to the listeners U1 through U3 into consideration, before the medium to high tones of the reproduced multichannel audio contents are provided to the listeners U1 through U3 individually listening to the contents by way of the headphones HP1 through HP3. Thus, the low tones output from the woofer UH of the measurement speaker 91 and the medium to high tones output from the headphones HP1 through HP3 are smoothly linked to each other so that it is possible to provide a feeling of optimum sound image to all the listeners regardless of their listening positions.

Then, as a result, with the multichannel reproduction system 90, it is possible to prevent in advance a phenomenon where the listener can hear only either of the low tones output from the woofer UH of the measurement speaker 91 and the medium to high tones output from the headphones HP1 through HP3, a phenomenon where the listener hears the two types of reproduced sounds as two isolated types of sounds, a (dip) phenomenon where the sound level of a specific frequency band of the reproduction band dips and becomes inaudible and/or a (peak) phenomenon where the sound level of a specific frequency band rises abruptly, all of which give a strange feeling to the listeners, from arising.

Thus, with the above-described arrangement, the multichannel reproduction system 90 minimizes sound leaks to the environment and provides a feeling of optimum sound image to all the listeners U1 through U3 regardless of their listening positions so that the listeners can listen to reproduced sounds of the highest quality, which the external noise NSS is reduced from.

### (3) Other embodiments

While the headphone HP1 of the first embodiment has a one-way structure of arranging a left speaker unit SU1 and a right speaker unit SU2 for medium to high tones in the above description, the present invention is by no means limited thereto and each of the headphones may alternatively have a two-way structure of arranging two speaker units including a speaker unit for medium tones and a speaker unit for high tones in each of the cabinets K1, K2.

In the multichannel reproduction systems 40, 50, 60 and 70 of the above-described first embodiment, each of the headphones HP1 correction sections 42 and 62 is formed by independently using an HP1 gain adjusting circuit 42A, an HP1 filter 42B, an HP1 delay circuit 42C and an HP1 power amplifier 42D and each of the headphones HP2 correction sections 43 and 63 is formed by independently using an HP2 gain adjusting circuit 43A, an HP2 filter 43B, an HP2 delay circuit 43C and an HP2 power amplifier 43D, whereas each of the headphones HP3 correction sections 44 and 64 is formed by independently using an HP3 gain adjusting circuit 44A, an HP3 filter 44B, an HP3 delay circuit 44C and an HP3 power amplifier 44D. However, the present invention is by no means limited thereto and a single digital filter may alternatively be used to integrally realize the effect of a gain adjusting circuit, a filter, a delay circuit and a power amplifier.

While the sound processor 11 is responsible for the above-described various signal processes of the first embodiment, the present invention is by no means limited thereto and a signal processing circuit arranged in the inside of each of the cabinets of the headphones HP1 through HP3 may alternatively be made responsible for the above-described various signal processes.

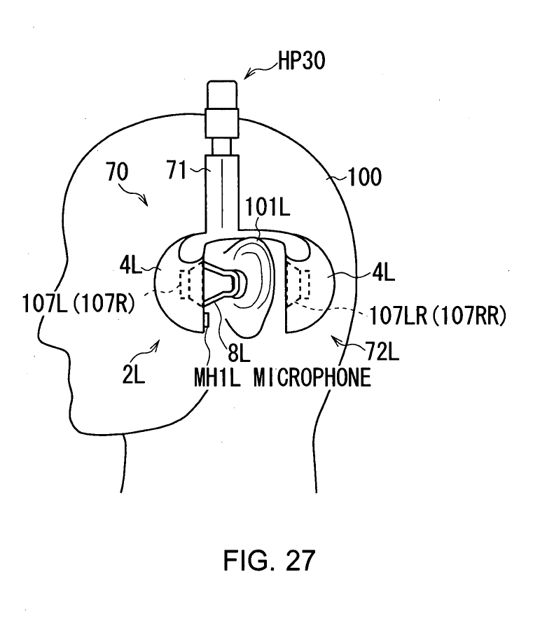

While headphones HP11 through HP13 having an ear speaker type structure are used in the above-described second embodiment, the present invention is by no means limited thereto and ear speaker type headphones HP30, each having a left rear speaker unit 107LR and a right rear speaker unit 107RR in addition to the speaker units 107L and 107R (FIGS. 13 through 16) arranged respectively at the front side of the left ear and at the front side of the right ear as shown in FIG. 27 may alternatively be used.

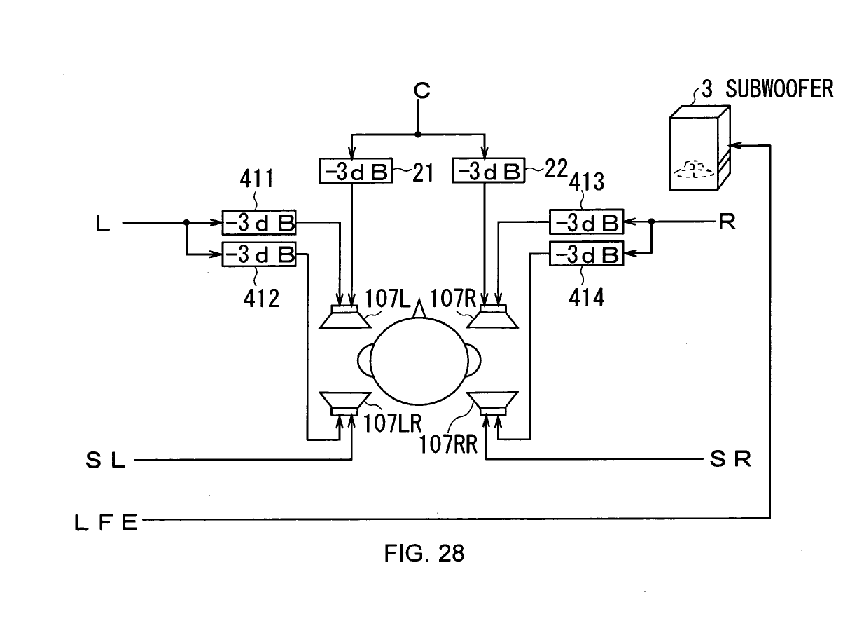

With this arrangement, the audio signals of 5.1ch multichannel audio contents for the L-channel for the left front speaker, the R-channel for the right front speaker, the C-channel for the center speaker, the SL-channel for the left surround speaker and the SR-channel for the right surround speaker are output from the speaker units 107L and 107R arranged respectively at the front sides of the left and right ears and the speaker units 107LR and 107RR arranged respectively at the rear sides of the left and right ears as sounds of those channels as shown in FIG. 28. In FIG. 28, the components corresponding to those of FIG. 5 are denoted respectively by the same reference symbols. Thus, it is possible to give a comfortable feeling of direction of sound image that the contents producer intended to give even more three-dimensionally.

In this case, as for the audio signal output by way of the C-channel for the center speaker, since there is only a single center speaker, the volume level of the C-channel for the center speaker rises relative to that of any of the other channels (L-channel, R-channel, SL-channel and SR-channel) to put it out of balance when the sounds of the C-channel are output to the speaker units 107L and 107R. Therefore, to avoid this problem, the gain of the audio signal is reduced by −3 dB by means of level reduction circuits 21 and 22 before it is supplied to the speaker units SU3 and SU4.

Similarly, as for the audio signal output by way of the L-channel for the left front speaker, the volume level of the L-channel rises relative to that of any of the other channels (C-channel, R-channel, SL-channel and SR-channel) to put it out of balance when the sounds of the L-channel are output to the speaker units 107L and 107LR. Therefore, to avoid this problem, the gain of the audio signal is reduced by −3 dB by means of level reduction circuits 411 and 412.

The above description also applies to the R-channel for the right front speaker. Thus, the gain of the audio signal is reduced by −3 dB by means of level reduction circuits 413 and 414.

However, the present invention is by no means limited to the above-described arrangement. More specifically, in addition to arranging speaker units at the front and rear sides of each of the left and right ears, (although not shown) two more speaker units may be arranged at the outer lateral sides of the left and right ears respective to make the total number of speaker units of the ear speaker type headphone equal to six.

While measurement tones are collected by the microphones MH1L, MH1R, MH2L, MH2R, MH3L, MH3R for the noise-canceling feature that are fitted to the headphones HP11 through HP13 of the multichannel reproduction system of the second embodiment in the above description, the present invention is by no means limited thereto and the measurement tones may alternatively be collected by microphones fitted to the headphones HP11 through HP13 as hearing aids or by microphones fitted to head sets for the purpose of communications.

While non-closed type headphones HP1 through HP3 and HP11 through HP13 are used in the above-described first and second embodiments, the present invention is by no means limited thereto and open type headphones that may have a profile and a structure selected from various profiles and structures such as inner ear type headphones may alternatively be used so long as such headphones are not of the closed type having a structure that completely closes the left and right ears at the circumferences thereof but of a type having a gap, if slightly.

While the analysis/reproduction engine 402 arranged in the inside of the sound processor 11 is adapted to digitally execute a noise-canceling process in the above-described second embodiment, the present invention is by no means limited thereto and it may alternatively be adapted to execute an analog noise-canceling process.

While each of the above-described multichannel reproduction systems 1, 40, 50, 60, 70, 90 according to the embodiments of the present invention includes non-closed type headphones HP1 through HP3 or HP11 through HP13, a subwoofer 3 or woofers UH of measurement speakers 91, whichever appropriate, and a sound processor 11 that operates as a signal dividing unit and a signal processing unit to form an acoustic system, the present invention is by no means limited thereto and it may alternatively include non-closed type headphones having a circuit configuration selected from various possible circuit configurations, a subwoofer, the signal dividing unit and the signal processing unit to form an acoustic system.

An acoustic system, an acoustic apparatus and an optimum sound filed generation method according to the embodiment of the present invention can find applications not only in indoor environments such as living rooms but also in intra-vehicle environments of various vehicles and intra-cabin environments of airplanes where a plurality of listeners can commonly listen to the sounds of multichannel audio contents simultaneously.

It should be understood by those skilled in the art that various modifications, combinations, sub-combinations and alterations may occur depending on design requirements and other factors insofar as they are within the scope of the appended claims or the equivalents thereof.

What is claimed is:

1. An acoustic system comprising;
a plurality of non-closed type headphones;
a subwoofer;
dividing means for outputting the first signal not higher than a predetermined frequency to the subwoofer out of the multichannel reproduction signals supplied from a sound source and, at the same time, outputting the second signal higher than the predetermined frequency to the plurality of non-closed type headphones; and
signal processing means for processing the signals for each of the channels corresponding to the plurality of non-closed type headphones, considering links of the low tones to be output from the subwoofer according to the first signal and medium to high tones to be output from the plurality of non-closed type headphones according to the second signal.

2. The acoustic system according to claim 1, wherein
the signal processing means has a frequency characteristic adjusting feature of adjusting the frequency characteristics for the multichannel reproduction signals in order to make the frequency characteristics of the subwoofer for outputting sounds corresponding to the first signal match the frequency characteristics of the non-closed type headphones for outputting sounds corresponding to the second signal.

3. The acoustic system according to claim 1, wherein
the signal processing means has a gain adjusting feature of adjusting the gain of the multichannel reproduction signals in order to make the output level of the subwoofer for outputting sounds corresponding to the first signal to be balanced with the output level of the non-closed type headphones for outputting sounds corresponding to the second signal.

4. The acoustic system according to claim 1, wherein
the signal processing means has a delay time defining feature of defining a delay time for the multichannel reproduction signals in order to make the phase of operation of the subwoofer for outputting sounds corresponding to the first signal match the phase of operation of the non-closed type headphones for outputting sounds corresponding to the second signal.

5. The acoustic system according to claim 1, wherein
the signal processing means has a down-mixing feature of down-mixing the multichannel reproduction signals to two channels by means of a digital signal process, maintaining the feeling of virtual sound image.

6. The acoustic system according to claim 1, wherein
the non-closed type headphones have a plurality of independent headphone drivers for directly reproducing the multichannel reproduction signals for the insides of the headphone cabinets.

7. The acoustic system according to claim 1, wherein
the non-closed type headphones have microphones arranged near the speaker units, and
the signal processing means outputs sounds from a speaker arranged separately, computationally determines the delay of the sounds according to the results of detection obtained by collecting them by means of the microphone, outputs sounds from the speaker units, computationally determines the gain and the frequency characteristics of the sounds according to the results of detection obtained by collecting the sounds by means of the microphone and generates the second signal corresponding to the gain and the frequency characteristics for each of the channels.

8. An acoustic apparatus comprising:
dividing means for outputting the first signal not higher than a predetermined frequency to a subwoofer out of the multichannel reproduction signals supplied from a sound source and, at the same time, outputting the second signal higher than the predetermined frequency to a plurality of non-closed type headphones; and
signal processing means for processing the signals for each of the channels corresponding to the plurality of non-closed type headphones, considering links of the low tones to be output from the subwoofer according to the first signal and medium to high tones to be output from the plurality of non-closed type headphones according to the second signal.

9. The acoustic apparatus according to claim 8, wherein
the signal processing means has a frequency characteristic adjusting feature of adjusting the frequency characteristics for the multichannel reproduction signals in order to make the frequency characteristics of the subwoofer for outputting sounds corresponding to the first signal match the frequency characteristics of the non-closed type headphones for outputting sounds corresponding to the second signal.

10. The acoustic apparatus according to claim 8, wherein
the signal processing means has a gain adjusting feature of adjusting the gain of the multichannel reproduction signals in order to make the output level of the subwoofer for outputting sounds corresponding to the first signal to be balanced with the output level of the non-closed type headphones for outputting sounds corresponding to the second signal.

11. The acoustic apparatus according to claim 8, wherein
the signal processing means has a delay time defining feature of defining a delay time for the multichannel reproduction signals in order to make the phase of operation of the subwoofer for outputting sounds corresponding to the first signal match the phase of operation of the non-closed type headphones for outputting sounds corresponding to the second signal.

12. The acoustic apparatus according to claim 8, wherein
the signal processing means has a down-mixing feature of down-mixing the multichannel reproduction signals to two channels by means of a digital signal process, maintaining the feeling of virtual sound image.

13. The acoustic apparatus according to claim 8, wherein
the non-closed type headphones have a plurality of independent headphone drivers for directly reproducing the multichannel reproduction signals for the insides of the headphone cabinets.

14. The acoustic apparatus according to claim 8, wherein
the non-closed type headphones have microphones arranged near the speaker units, and
the signal processing means outputs sounds from a speaker arranged separately, computationally determines the delay of the sounds according to the results of detection obtained by collecting them by means of the microphone, outputs sounds from the speaker units, computationally determines the gain and the frequency characteristics of the sounds according to the results of detection obtained by collecting the sounds by means of the microphone and generates the second signal corresponding to the gain and the frequency characteristics for each of the channels.

15. A sound field generation method for generating a sound field by using sounds output from a plurality of non-closed type headphones and sounds output from a subwoofer, the method comprising:
a dividing step of outputting the first signal not higher than a predetermined frequency to a subwoofer out of the multichannel reproduction signals supplied from a sound source and, at the same time, outputting the second signal higher than the predetermined frequency to a plurality of non-closed type headphones; and
a signal processing step of processing the signals for each of the channels corresponding to the plurality of non-closed type headphones, considering links of the low tones to be output from the subwoofer according to the first signal and medium to high tones to be output from the plurality of non-closed type headphones according to the second signal.

16. An acoustic system comprising;
a plurality of non-closed type headphones;
a subwoofer;
a dividing unit that outputs the first signal not higher than a predetermined frequency to the subwoofer out of the multichannel reproduction signals supplied from a sound source and, at the same time, outputs the second signal higher than the predetermined frequency to the plurality of non-closed type headphones; and
a signal processing unit that processes the signals for each of the channels corresponding to the plurality of non-closed type headphones, considering links of the low tones to be output from the subwoofer according to the first signal and medium to high tones to be output from the plurality of non-closed type headphones according to the second signal.

17. An acoustic apparatus comprising:
a dividing unit that outputs the first signal not higher than a predetermined frequency to a subwoofer out of the multichannel reproduction signals supplied from a sound source and, at the same time, outputs the second signal higher than the predetermined frequency to a plurality of non-closed type headphones; and
a signal processing unit that processes the signals for each of the channels corresponding to the plurality of headphones, considering links of the low tones to be output from the subwoofer according to the first signal and medium to high tones to be output from the plurality of non-closed type headphones according to the second signal.
